(19) United States
(12) Patent Application Publication
(10) Pub. No.: US 2026/0227534 A2
(43) Pub. Date: Aug. 6, 2026

(54) SYSTEM AND METHOD FOR DETERMINING CHARGED PARTICLE TRAJECTORIES USING A DIRECTIONAL PARTICLE DETECTOR

(71) Applicant: Joseph Nathaniel Berlin, Coatesville, PA (US)

(72) Inventor: Joseph Nathaniel Berlin, Coatesville, PA (US)

(21) Appl. No.: 19/094,701

(22) Filed: Mar. 28, 2025

(51) Int. Cl. G01T 5/00; G01T 1/20; G01T 1/22; G01T 1/24; G01T 5/06

(52) U.S. Cl. CPC G01T 5/002; G01T 5/06; G01T 1/201; G01T 1/22; G01T 1/24

(57) ABSTRACT

Systems and methods for measuring trajectories of charged particles and for charged particle radiography and charged particle tomography are presented, comprising one or more directional particle detectors (DPDs). A DPD produces a directional measurement of a charged particle by determining the transit distance of the charged particle through a detector medium which is elongated is a single spatial dimension, or by determining the amount of energy deposited by the charged particle in a detector medium which is elongated is a single spatial dimension. Also presented are charged particle transmission imaging systems, charged particle scattering imaging systems, composite DPDs of various geometries, embodiments allowing for the monitoring of a plurality of detector medium columns by as few as one optical sensor, various shapes and compositions of detector medium columns, DPDs elongated in two spatial dimensions, fields of application, and discussions about the fundamental advantages of DPD over coincidence-based charged particle velocimetry.

### FIELD

This disclosure relates to charged particle detectors used to determine trajectories of charged particles.

### BACKGROUND

Conventional methods for determining the trajectory of a charged particle relies on a single methodology, the coincidence method. A single modern electronics-based charged particle detector does not have the ability to detect the direction of an incident charged particle: it can only detect that a charged particle was incident on the detector. To detect the direction of travel of a charged particle, it is necessary to detect the incidence of a charged particle as it passes through a first detector, and the incidence of the same charged particle as it passes through a second detector, and then infer the charged particle's trajectory as the straight line that passes through the two detectors. To exclude charged particle detection events which were caused by different charged particles (“accidental coincidences”), the coincidence system excludes all pairs of detection events except those that occur within a small, predetermined time interval. This is the coincidence method.

The coincidence method is significantly constrained by fundamental limitations. Implementing the coincidence method requires charged particle detectors with rapid response times, coupled to similarly swift data acquisition systems and time comparator circuits. Electronic components and data systems that can meet these timing requirements have high cost. Additionally, achieving a high angular resolution with the coincidence method requires spacing the two detectors far away from each other compared to the size of the detectors. This can become a problem when a detector array must fit into a confined space or when the mean free path of the charged particle under investigation is extremely short. Furthermore, as distances between detectors in a coincidence array decrease, faster response times are required to resolve the shorter coincidence time windows. Therefore, the minimum possible size of coincidence method detector arrays, and likewise the maximum possible angular and spatial resolution achievable by using the coincidence method, is constrained by the response time of state-of-the-art charged particle detectors.

The following are a series of discussions about the limitations of the coincidence method when applied in a wide variety of industries in the service of charged particle velocimetry.

Muon tomography and muon radiography, collectively called muography or muon imaging, measures the flux of naturally-occurring cosmic ray muons that have been transmitted by or have been scattered by matter, and processes those measurements to generate a map of the internal composition of that matter. Unlike other forms of radiation, muons can penetrate high density matter, such as rock, for hundreds of meters. Muons are selectively absorbed and scattered by higher density matter. Thus, muography can image the density variations within large volumes of high-density matter.

Muon tomography can be further divided into muon transmission tomography and muon scattering tomography. Muon transmission tomography measures the flux of muons that have passed through a volume of matter, providing information on its density distribution and hence its internal structure. Muon scattering tomography measures the change in the trajectory of a muon when scattered by a volume of matter, offering insight into the composition and material properties of the volume of matter. While transmission tomography excels in imaging dense materials, scattering tomography is advantageous for discerning subtle variations in composition and detecting lighter elements as well as for faster muography imaging.

Muography has found strong applications in mining, oil exploration, archaeology, civil engineering, and border security. The prior art teaches of applications of muography which include ore body exploration, well logging, monitoring shipping containers or vehicles for contraband, slag heap monitoring, monitoring for slope stability, subsurface fluid monitoring, determining slag thickness at the bottom of steel furnaces, inspecting nuclear waste and nuclear reactors, inspecting underground structures, monitoring volcanism, monitoring glaciers, monitoring tides, exploration or monitoring of geological faults, as one-time-pads for cryptography, and others.

In the field of muography, the detection apparatus for tracking muons can be costly, involving large-scale detectors and precise electronics to perform coincidence logic and thereby determine charged particle trajectories. Further, existing muon tomography systems often have restrictions on angular resolution: the spatial arrangement and performance of available detector modules can limit the accuracy with which muon paths can be reconstructed. This, in turn, affects the clarity and detail of the resulting tomographic images, the real-time measurement of muon activity is constrained by the rate at which detectors can process incoming signals and the computational complexity of reconstructing images. As a result, many muon tomography systems operate with a significant delay between data capture and final image generation.

In the field of muography in the service of ore body exploration, muography imaging studies often take weeks or months due to the relatively sparse deployment of detectors, because borehole coincidence method detector arrays are expensive. The angular resolution of the resulting muon radiographs and muon tomographs is often coarser than desired. The prior art requires a relatively large borehole diameter. The temperature, pressure and radiation conditions of some muography environments are not well-suited for fast-response photodetectors and their associated electronics. The relatively high energy consumption of prior art borehole detector arrays is sometimes a limiting factor in their deployment.

In the field of muography in the service of container and vehicle inspection for national security purposes, the high cost of existing muon scattering tomography systems limits throughput and widespread deployment. Furthermore, the spatial resolution of these systems is limited by the number of detectors employed and thereby limits the system's ability to detect small variations in density and its ability to identify very small objects-this further impedes their effectiveness in national defense. Furthermore, the angular resolution of these systems is limited by the fundamental limitations of the coincidence method.

Therefore, there is a need to reduce cost and size, improve angular and spatial resolution, and enable real-time measurement in muography, which would broaden its accessibility and enhance its utility across various industrial, scientific, and security applications.

In the field of cosmic ray physics, existing solutions employ coincidence-based detection methods that are costly due to the need for high-speed electronics and high-speed optical sensors. In addition, this approach limits angular resolution, as the geometry and spacing of the arrays constrain the precision with which incoming trajectories can be reconstructed. Because of the spatial requirements, coincidence-based systems are difficult to miniaturize for portable or space-limited applications. Finally, real-time analysis of cosmic ray events is impeded by the complexity of data collection and post-processing steps (which limit its value in multi-messenger astrophysics detector networks, for example). Therefore, there is a need to reduce cost, improve angular resolution, decrease spatial requirements, and enable real-time measurement of charged particles in the service of cosmic ray physics.

In the field of proton therapy, the measurement of proton trajectory relies on the coincidence method, which suffers from several drawbacks. First, implementing coincidence detection typically involves sophisticated—and costly—hardware, including multiple detector arrays and high-speed electronics capable of resolving very short time intervals. Second, the coincidence technique inherently constrains angular resolution, as detectors must be spaced and oriented according to the geometric requirements for capturing coincident events. This limitation in angular resolution can reduce the precision with which proton trajectories can be characterized. Third, the data acquisition and post-processing needed to correlate coincident signals introduce latency, making real-time imaging of the proton beam challenging. Without the ability to quickly adjust treatment parameters based on immediate feedback, clinical applications may face reduced flexibility and accuracy in delivering targeted doses. Therefore, there is a need to reduce cost, improve angular resolution, and make possible real-time imaging of protons during therapy in order to enhance their safety, efficacy and accessibility.

In the field of Positron Emission Tomography (PET) scans, current detection techniques rely on coincidence detection, which has several drawbacks. First, PET scanners are among the most expensive medical imaging devices on the market, largely because they require highly specialized detectors, electronics capable of sub-nanosecond timing resolution, and often sophisticated cooling and shielding systems. Second, while coincidence detection methods can offer good spatial resolution, they still have limitations on angular resolution due to the fixed geometry and spacing of detector arrays around the imaging ring. These geometric constraints can limit the precision with which physicians and researchers can localize tracer uptake in patient tissues. Finally, the large volumes of data generated by coincidence-based methods make real-time processing difficult. This lack of real-time measurement can slow down diagnostic workflows and impede immediate clinical decision-making, as significant data processing and reconstruction must be completed before results are available. Therefore, there is a need to reduce cost, improve angular resolution, and enable real-time imaging capabilities for PET scans, which would advance both the clinical and research utility of this important diagnostic modality. In the field of semiconductor ion doping, achieving precise control over dopant concentrations is critical for device performance and yield. Conventional ion implantation systems typically rely on costly and complex hardware to accurately deliver and measure the intended dose. Furthermore, these systems have limited angular resolution, as they usually require fixed beamline geometries and rigid mechanical scanning mechanisms to distribute dopants across the wafer surface. This can lead to inconsistencies in doping profiles. Real-time monitoring of dopant levels remains challenging or prohibitively expensive due to the need for sophisticated in-situ diagnostics and high-speed electronics, resulting in slower feedback loops and potential wafer-to-wafer variability. Therefore, there is a need to reduce the cost, improve angular resolution, and enable real-time measurement of ion beams in the semiconductor doping process to enhance manufacturing precision, device performance, and overall production efficiency.

In the field of electron beam (e-beam) manufacturing—such as e-beam lithography, welding, or additive manufacturing—precise calibration and real-time monitoring of the beam are critical for achieving high-quality results. While current systems employ sophisticated hardware to generate and steer electrons, many rely on coincidence-based methods to measure and correlate beam parameters. These measurement setups can be costly, in part because they require multiple detectors and complex electronics to capture coincident signals. Moreover, the geometry and arrangement needed for coincidence detection often limit angular resolution, restricting the level of precision achievable when assessing beam quality or alignment. The bulk of such measurement configurations can also create large spatial requirements, making them difficult to integrate into existing production environments. Finally, reliance on coincidence-based systems can impede real-time feedback, since correlating signals from multiple detectors introduces delays in data processing and analysis. Therefore, there is a need for a measurement solution that replaces the coincidence method to reduce cost, improve angular resolution, decrease spatial requirements, and enable real-time measurement.

In the field of positron annihilation spectroscopy (PAS), researchers use charged particle detection to study the behavior of positrons before or during interactions with a sample.

Coincidence-based systems can be expensive to purchase and operate, largely due to the precision timing hardware needed to capture simultaneous measurements. Furthermore, the geometric constraints of a coincidence-based approach can limit angular resolution. Further, coincidence arrays require significant space to accommodate multiple detectors, making them less adaptable to various laboratory or industrial environments. Finally, correlating signals from multiple detectors per the coincidence method introduces latency and computational overhead. Therefore, there is a need for a measurement solution that replaces coincidence-based charged particle detection in PAS to reduce cost, improve angular resolution, minimize spatial requirements, and enable real-time measurement.

In the field of nuclear fusion reactor development, precise measurement and tracking of charged particles—such as ions or fast electrons—play a critical role in optimizing plasma confinement and improving overall reactor performance. Traditional monitoring methods often rely on coincidence-based systems that require multiple detectors and specialized high-speed electronics to correlate the trajectories of charged particles. Such setups can be prohibitively expensive. Moreover, the geometry and positioning constraints of coincidence-based measurement can reduce angular resolution, limiting the accuracy with which charged particle trajectories can be determined. These systems may also occupy significant physical space, posing challenges for reactor environments where space is at a premium and access can be limited. Finally, the required signal-correlation steps can introduce delays, complicating efforts to achieve real-time feedback on plasma behavior. Therefore, there is a need for a measurement solution that replaces coincidence-based charged particle detection to reduce costs, enhance angular resolution, minimize spatial requirements, and enable real-time diagnostic feedback.

In the field of high-precision neutron generation via proton bombardment, controlling and monitoring the proton beam's trajectory, intensity, and other characteristics are critical for achieving consistent neutron output. Conventional systems rely on coincidence-based detection to measure the charged particles' paths. Coincidence-based detection systems can be prohibitively expensive due to the need for multiple detectors and sophisticated, high-speed timing hardware. Additionally, the geometry required for coincidence detection limits angular resolution, constraining the level of precision with which the proton beam can be tracked or calibrated. Finally, real-time analysis of beam parameters can be difficult to achieve, as correlating signals from multiple detectors typically introduces latency, hindering dynamic control or on-the-fly adjustments. Therefore, there is a need for a measurement solution that replaces coincidence-based charged particle detection to reduce overall cost, improve angular resolution, and enable real-time measurement.

In the field of ion thruster propulsion for satellites and deep-space missions, precise monitoring of ion beam parameters—such as beam current, velocity distribution, and divergence—is critical for optimizing thrust and ensuring reliable long-duration operation. Traditional diagnostic systems frequently rely on coincidence-based detection methods to correlate signals from multiple sensors, enabling measurements of ion trajectories and velocities. However, these methods tend to be expensive and bulky, owing to the need for multiple detectors with high-speed, high-precision timing electronics. The geometry required for coincidence detection also constrains angular resolution, limiting how accurately the ion beam can be characterized. Additionally, large multi-detector setups can be difficult to integrate within the mass and volume constraints of a spacecraft. Further, real-time feedback on ion beam performance can be challenging to achieve, as correlating signals from multiple detectors introduces processing delays, making it more difficult to dynamically adjust thruster parameters in response to changing mission conditions. Therefore, there is a need for a measurement solution that replaces coincidence-based charged particle diagnostics to reduce cost, improve angular resolution, decrease spatial requirements, and enable real-time measurement.

In the field of carbon-ion therapy for cancer treatment, precise monitoring of carbon-ion beam characteristics—such as energy, intensity, and direction—is critical to maximizing tumor targeting while sparing healthy tissue. Conventional measurement systems rely on coincidence-based methods that require multiple detectors and highly precise timing electronics to track carbon-ion trajectories. These setups can be prohibitively expensive, in part due to the specialized nature of high-speed detector hardware. Additionally, the geometry necessary for coincidence detection inherently limits angular resolution, restricting the level of accuracy with which the beam profile can be characterized. Finally, the requirement to correlate signals from multiple detectors can lead to processing delays that hamper real-time dose verification and adaptive treatment strategies. Therefore, there is a need for a measurement solution that replaces coincidence-based charged particle detection to reduce costs, enhance angular resolution, and enable real-time monitoring.

In the field of mass spectrometry, accurate measurement of ion trajectories and time-of-flight is crucial for identifying and quantifying sample constituents. Traditional approaches incorporate coincidence-based detection, requiring multiple sensors and tightly synchronized electronics to correlate signals from charged particles. These methods often increase both the capital cost and operational complexity of a mass spectrometer, as precision timing hardware and multiple detector modules must be integrated. Additionally, spatial arrangements necessary for coincidence detection place a limit on angular resolution, thereby reducing the fidelity of trajectory measurements. Such setups can also occupy substantial space within the instrument, challenging efforts to minimize system size or integrate mass spectrometers into compact environments. Finally, generating real-time data from coincidence-based systems is limited by fact that signal-correlation steps add latency to the measurement process. Therefore, there is a need to replace coincidence-based charged particle detection in mass spectrometry to lower costs, improve angular resolution, reduce spatial requirements, and enable near-instantaneous measurement.

In the field of Scanning Electron Microscopy (SEM), obtaining accurate and high-resolution images of a sample's surface depends on precise characterization of the electron beam and the secondary or backscattered electrons it induces. Some SEM systems incorporate coincidence-based detection techniques for charged particles, requiring multiple detectors and sophisticated timing electronics to correlate signals. This approach significantly increases the complexity and cost of the microscope, as it involves additional hardware components and high-speed signal-processing capabilities. Furthermore, the spatial arrangement needed for coincidence detection can limit angular resolution, thereby reducing the level of detail and accuracy with which electron trajectories are discerned. Such multi-detector setups can also occupy valuable instrument real estate, complicating SEM design and maintenance. Finally, real-time data acquisition can be hindered by the need to correlate signals from multiple detectors, introducing latency and reducing throughput. Therefore, there is a need for a measurement solution that replaces coincidence-based charged particle detection to lower costs, improve angular resolution, minimize spatial requirements, and allow for more immediate imaging feedback.

In the field of quantum computing component fabrication, producing highly coherent qubits and complex quantum circuitry requires meticulous control of materials and precise beam-based fabrication steps (e.g., ion implantation or electron-beam lithography). State-of-the-art systems use coincidence-based detection to measure charged particle trajectories during these fabrication processes. Coincidence methods involve multiple detectors and specialized timing electronics, which raise both cost and complexity. Additionally, the geometrical constraints of coincidence detection can limit angular resolution. Further, multi-detector setups occupy considerable space, complicating efforts to incorporate them into smaller cleanroom environments. Finally, the real-time monitoring and feedback essential for adjusting fabrication parameters on the fly may be delayed by the need to correlate signals from multiple detectors. Therefore, there is a need for a measurement solution that replaces coincidence-based charged particle detection to reduce cost, improve angular resolution, minimize spatial requirements, and enable real-time feedback.

In the field of proton radiography for industrial quality control, high-resolution imaging of dense or complex parts is crucial for detecting internal defects and ensuring product integrity. Current systems often rely on coincidence-based detection methods to measure proton trajectories, requiring multiple detectors and precision timing hardware. These setups can be costly and complex to operate, given the need for synchronous signal-correlation. Moreover, the geometry demanded by coincidence detection can limit angular resolution. Large multi-detector arrays can also consume significant space on the factory floor or within specialized inspection facilities, complicating integration and increasing overhead. Finally, achieving real-time or near-real-time imaging feedback is often hindered by the need to process correlated signals from multiple detectors, resulting in latency and reduced throughput. Therefore, there is a need to replace coincidence-based charged particle detection in proton radiography to reduce cost, enhance angular resolution, minimize spatial requirements, and enable real-time inspection.

The coincidence method is subject to fundamental constraints in every field where it is applied.

### SUMMARY

An example directional particle detector (DPD) comprises at least one detector medium. Each detector medium of the at least one detector medium has a longitudinal axis and has a length extending along the longitudinal axis. Each detector medium is configured to react to a charged particle passing therethrough. The DPD comprises at least one optical sensor configured to measure an amount of energy deposited in each detector medium of the at least one detector medium resulting from a reaction to the charged particle passing therethrough.

An example method of determining charged particle trajectory through a DPD comprises measuring, via an optical sensor of the DPD, an amount of energy deposited in each detector medium of at least one detector medium of the DPD resulting from a reaction to the charged particle passing through at least one detector medium of the at least one detector medium. Each detector medium of the at least one detector medium has a longitudinal axis and a length extending along the longitudinal axis. The method comprises determining, based on the measured amount of energy, a trajectory of the charged particle with respect to the longitudinal axis of the respective detector medium that reacted to the charged particle.

An example method of characterizing a volume of matter comprising positioning at least one first directional particle detector. Each first directional particle detector of the at least one first directional particle detector is configured to determine the trajectory of a charged particle passing therethrough after the charged particle passes through the volume of matter.

### BRIEF DESCRIPTION OF THE DRAWINGS

The drawings and accompanying written description are provided to illustrate certain exemplary embodiments of the present disclosure and do not limit its scope. Various modifications, substitutions, and alterations will be apparent to those skilled in the art upon reading this disclosure. All such variations are intended to fall within the spirit and scope of the present disclosure as defined by the claims. The figures and examples herein are merely illustrative and are not intended to limit the present disclosure to the specific embodiments disclosed.

FIG. 1 is a flow chart of an example method of determining the trajectory of a charged particle through a directional particle detector (DPD) in accordance with an embodiment of the disclosure;

FIG. 2 is an example dpd;

FIG. 3 is an example system for determining the trajectory of a charged particle, in accordance with an embodiment of the disclosure;

FIG. 4 is an example diagram of a transmission tomography (or radiography) system in accordance with an embodiment of the disclosure;

FIG. 5 is an example diagram showing an example target volume of matter under inspection, a plurality of DPDs embedded in boreholes and incident cosmic ray muons in accordance with an embodiment of the disclosure;

FIGS. 6A and 6B show an example composite DPD having detector medium columns arranged in a “Porcupine” arrangement;

FIG. 7 shows an example composite DPD having detector medium columns arranged in a “stack of fans” arrangement;

FIG. 8 shows an example composite DPD having detector medium columns arranged in a “Unidirectional” arrangement;

FIG. 9 shows an example composite DPD having detector medium columns arranged in a “Unidirectional” arrangement which employs a block of solid reflective material to form the boundaries that separate a plurality of columnar vacancies which are each filled with a fluid or solid detection medium;

FIG. 10A shows an example composite DPD comprising a plurality of detector medium columns being monitored remotely by a planar array of photodetectors (such as, for example, by an array of CMOS or by an array of CCDs) which is positioned behind a lens;

FIG. 10B show an example composite DPD comprising a plurality of detector medium columns being monitored remotely by a planar array of photodetectors (such as, for example, by an array of CMOS or by an array of CCDs) which is positioned behind a lens;

FIG. 11 shows an example composite DPD comprising a plurality of detector medium columns monitored by a planar array of photodetectors according to the disclosure;

FIG. 12 is an example diagram of a tomography (or radiography) system that makes charged particle scattering measurements by ascertaining a charged particle trajectory both before and after the charged particle transits a volume of matter;

FIG. 13 shows an example DPD comprising 180-degree “bends” in its constituent detector medium column, and which is monitored by one or more optical sensors which are directly affixed to the detector medium column(s) (one such optical sensor is depicted);

FIG. 14 shows an example composite DPD comprising a plurality of detector medium columns combined in parallel into a single non-detecting waveguide which is directly affixed to one or more optical sensors (one such optical sensor is depicted);

FIG. 15 shows an example detector medium that is elongated in two dimensions (in the form a plane or a disk), with an attached optical sensor, and a single “on-plane” charged particle is depicted which transits the full/maximal length through the detector medium;

FIG. 16 shows a perspective view of three composite DPDs inspecting a volume of matter, with each composite DPD comprising a plurality of detector medium planes (disks) affixed directly to an optical sensor;

FIG. 17 shows a perspective view of composite DPDs comprising a plurality of detector medium planes (disks) inspecting a volume of matter;

FIG. 18 shows a perspective view of composite DPDs comprising a plurality of detector medium planes (disks) inspecting a volume of matter;

FIG. 19 shows an example composite DPD comprising two parallel detector medium columns positioned coaxially, with one over top of each other and connected to each other by a waveguide, the detector medium columns being separated by a vacancy, with the bottom detector medium column affixed directly to an optical sensor;

FIG. 20 is a flow chart of an example method of determining whether the particle was scattered in a volume of matter and producing one or more radiographs and/or tomographs in accordance with an embodiment of the disclosure; and

FIG. 21 shows a block diagram of an example control system comprising a computing device as disclosed herein for determining the trajectory of a charged particle according to the disclosure.

### DETAILED DESCRIPTION

In accordance with the disclosure, the problem of determining the trajectory of a charged particle may be solved by determining the transit distance of a charged particle through a directional particle detector (DPD). In accordance with the disclosure, the problem of determining the transit distance of charged particle through a DPD is solved by determining the amount of energy deposited by the charged particle in a DPD. Therefore, in accordance with the disclosure, the problem of determining the trajectory of a charged particle is solved by determining the amount of energy deposited by the charged particle in a DPD. An example DPD and method of determining a trajectory of a charged particle is patented in U.S. Pat. No. 10,598,799 and U.S. Pat. No. 11,099,281 to Berlin, both patents are incorporated by reference herein. In these two patents, the transit length of the charged particle through a detector medium column is determined by substantially counting the photons created by the passage of a charged particle through a detector medium column. U.S. Pat. No. 10,598,799 and U.S. Pat. No. 11,099,281 recite a process that relies on counting photons, and not on an energy measurement (such as a power measurement, an intensity measurement, or an equivalent measurement). Counting photons is fundamentally distinct from making an energy measurement of a plurality of photons (such as a power or intensity measurement, among others) because simply counting photons ignores the energy of each photon.

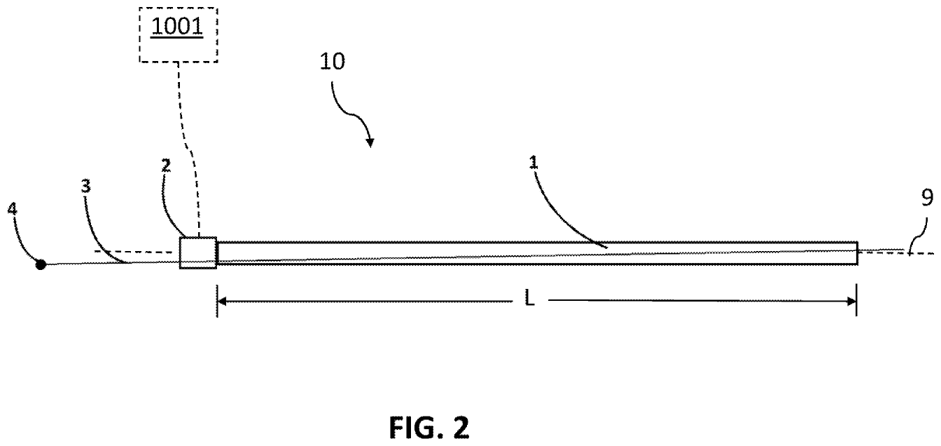

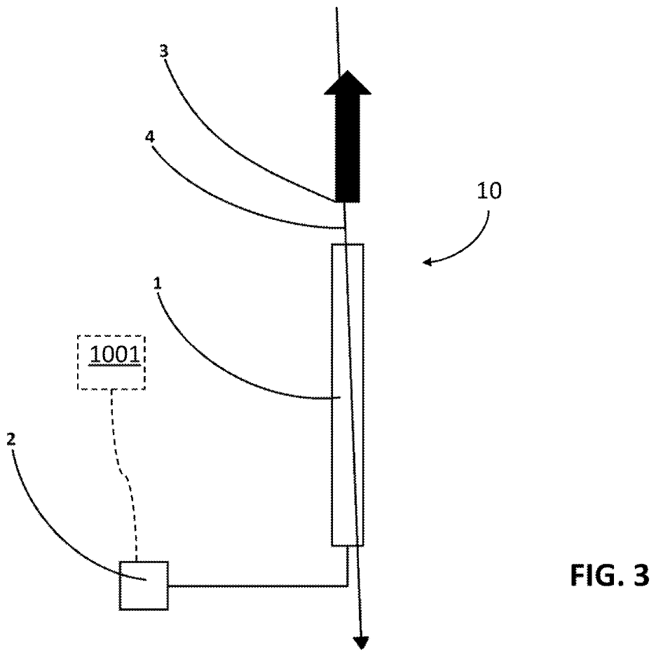

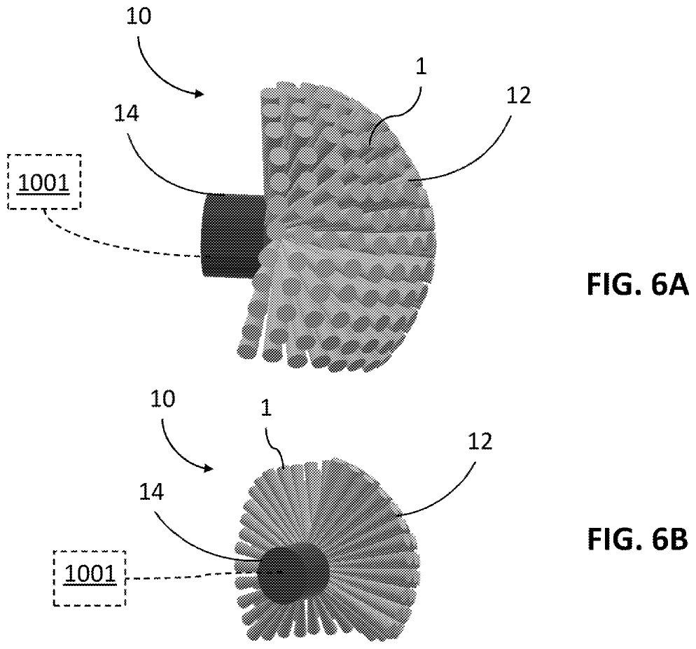

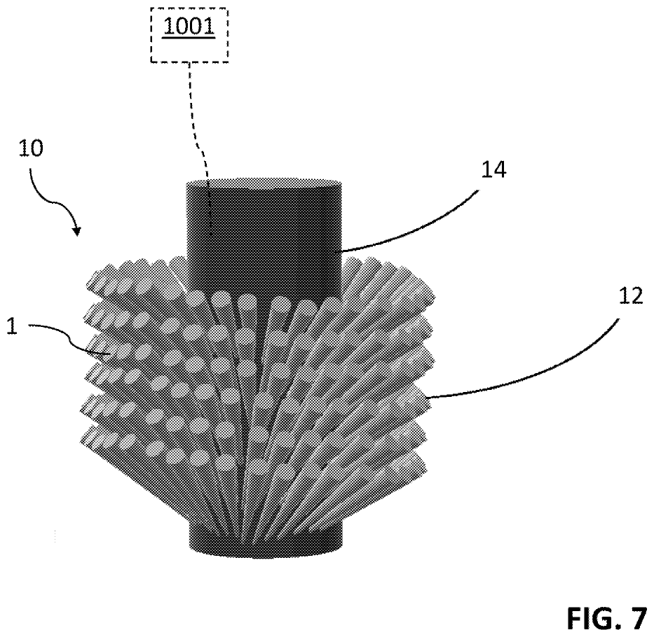

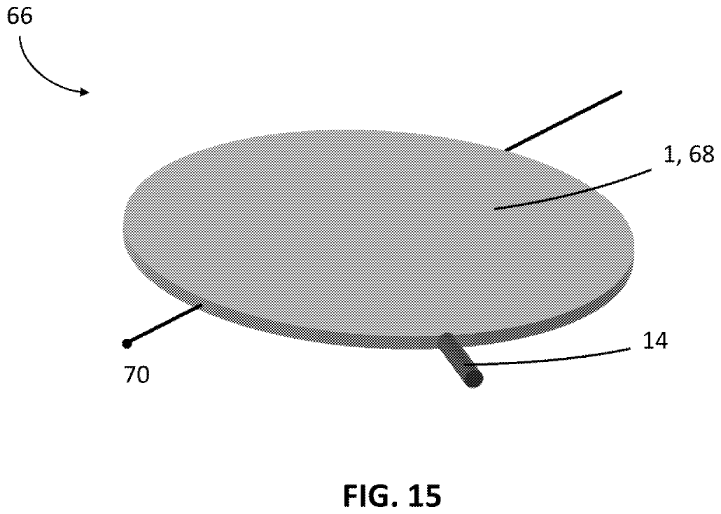

As shown in FIG. 2, an example DPD 10 according to the disclosure comprises at least one detector medium 1. The DPD 10 may comprise a plurality 12 of detector mediums 1 (as shown in FIGS. 6A-11 and 16-19). The detector medium 1 may have a longitudinal axis 9 and a length L extending along the longitudinal axis 9. The longitudinal axes 9 of respective detector mediums 1 may be transverse to one another (as shown in FIGS. 6A-7). Alternatively, the longitudinal axes 9 of respective detector mediums 1 may be parallel or substantially parallel (for example, within 5° of parallel) to one another. Optionally, the detector medium 1 may take the shape of a cylinder, a pyramid, a frustum of a cone, a frustum of a pyramid, or another substantially elongated geometric solid. The detector medium may have a cross-sectional area taken along a plane perpendicular or substantially perpendicular (for example within 10° of perpendicular) of the longitudinal axis 9 having any shape, but some examples of possible cross-sectional shapes include circles, squares, triangles, hexagons, and annuli. As shown in FIG. 15, in an example embodiment, the detector medium 1 may extend along two dimensions and form a circular disk or a plane or some other shape. The detector medium may comprise at least one of the following materials: a plastic scintillator, an organic crystal, a liquid scintillator, a composite, a transparent dielectric fluid, a transparent dielectric solid, or a combination of these materials. The detector medium 1 material may exhibit periodic vacancies, no vacancies, hollow cores, microstructures or combinations thereof. The detector medium 1 may comprise an electromagnetic (EM) field(s). The EM field(s) may cause a charged particle passing therethrough to lose, or potentially gain, energy. The detector medium 1 is configured to react to a charged particle passing through the detector medium. The charged particle may be a charged particle, including but not limited to a muon, an electron, a positron, a proton, a nuclei, an ion, a tau, an alpha, a pion, a kaon, or an exotic baryon. The reaction may be in the form of electromagnetic radiation. A charged particle passing through the detector medium 1 may cause energy deposition in the form of photon emission in the material through ionization, scintillation radiation, Cherenkov radiation, braking radiation, synchrotron radiation, thermal effects, phonon production, low-angle scattering, or any combination of these mechanisms. The detector medium 1 may produce the migration of photons generated therein by either internal refraction within the detector medium (such as in a fiber optic) or by specular reflection provided by a reflective surface encircling the detector medium, or by some other means. Optionally, in an example embodiment, the detector medium 1 comprises a substantially straight line of optically-transparent bubble chambers monitored by one or more laser beams. The line of bubble chambers may form a detector medium column. The bubble chambers are adapted to detect a charged particle, and these bubble chambers are bisected by at least one laser beam. The laser beam passes through all of the optically-transparent bubble chambers and emerges from the distal bubble chamber at a nominal intensity in the absence of a charged particle detection event. The DPD in this example embodiment comprises at least one optical sensor 2 configured to generate a signal indicative of an amount of energy deposited into the detector medium 1 caused by the reaction to the charged particle. For example, when the detector medium comprises the line of bubble chambers, the laser beam(s) may be monitored by one or more optical sensors at one or more ends of the line of bubble chambers. The molecular condensation effect produced by a charged particle passing through one or more bubble chambers attenuates the laser beam reaching the optical sensor(s). The degree of attenuation of the laser beam is directly proportional to the number of bubble chamber segments that the charged particle traversed, which is directly proportional to the transit length of the charged particle through the detection medium. The preceding example aspect is described in order to demonstrate that there are multiple ways by which the transit distance of the charged particle through the detector medium may be determined in a DPD, and not only by way of an energy measurement. The present disclosure contemplates that the DPD may utilize any suitable technique or methodology to determine the transit distance of the charged particle through the detector medium column, including methods that are not explicitly described herein and those that may be developed in the future. Accordingly, the scope of the disclosure is not limited to the specific examples, embodiments, or aspects set forth herein.

As shown in at least FIGS. 6-11, an example composite DPD 10 may comprise a plurality 12 of detector mediums 1 and at least one optical sensor 2 configured to generate a signal indicative of an amount of energy deposited into each detector medium caused by a reaction to a charged particle passing therethrough. Each detector medium 1 of the composite DPD may have a respective longitudinal axis and length (as shown in FIG. 2). The longitudinal axes 9 of respective detector mediums may be transverse to one another. Alternatively, the longitudinal axes of respective detector mediums may be parallel or substantially parallel (for example, within 5° of parallel) to one another. Optionally, the composite DPD may further comprise a support structure 14. The support structure 14 may comprise the at least one optical sensor. The plurality 12 of detector mediums 1 may be coupled to the support structure 14. The plurality of detector mediums may be coupled to the support structure in a porcupine arrangement (shown in FIGS. 6A and 6B). A porcupine arrangement refers to an arrangement of pointing directions of the detector medium columns that spans a substantial or complete angular range, such as the entire azimuthal and zenith coordinate ranges (with respect to a spherical coordinate system). The plurality 12 of detector mediums 1 may be coupled to the support structure 14 in a stack of fans arrangement (shown in FIG. 7). A stack of fans arrangement refers to an arrangement of pointing directions of the detector mediums 1 that spans a substantial or complete azimuthal coordinate range but does not span an appreciable zenith coordinate range (with respect to a spherical coordinate system). The photons created by the passage of the charged particle through each detector medium 1 may be detected by one or more optical sensor which is in optical communication with one or more detector medium columns. U.S. Pat. No. 10,598,799 and U.S. Pat. No. 11,099,281 (Berlin) teach that an optical sensor is coupled to a detector medium column(s). In accordance with the present disclosure, the optical sensor(s) may be remotely coupled to the detector medium column(s) with an intervening fluid or vacuum gap such as an air gap, or the optical sensor(s) may be remotely coupled to the detector medium column(s) by a fiber optic or other solid material, or it may be directly coupled to the detector medium column(s). In accordance with the present disclosure, a large number of detector medium columns may be simultaneously monitored by as few as one optical sensor.

The relatively slow-response optical sensors that can be used in an example DPD may be less expensive than the fast-response optical sensors required for the coincidence method. Here, “response time” refers to the duration between the arrival of incident photons at the photodetector and the generation of an intelligible output signal, with the fast-response sensors providing significantly shorter response times to support the operational demands of the coincidence method. The optical sensors used in a DPD may be selected from photodiodes, CMOS photodetectors, CCD photodetectors, silicon photomultipliers, avalanche photodiodes, perovskite photodetectors, photomultiplier tubes, solid state photodetectors, organic photodiodes, microchannel plates, quantum dot detectors, transition edge sensors, superconducting nanowire detectors, photomagnetic detectors, hybrid photodetectors, germanium photodetectors, InGaAs photodetectors, planar waveguide photodetectors, schottky photodetectors, bolometers, pyroelectric detectors, PIN photodiodes, metal-semiconductor-metal photodetectors, thermopiles, novel material-based photodetectors, plasmonic-enhanced photodetectors, graphene-based photodetectors, photonic detectors, or other photodetectors. DPDs may employ relatively expensive, fast-response optical sensors, but a DPD's ability to employ relatively inexpensive, slow-response optical sensors may be an advantage over prior art.

The amount of energy deposited in the detector medium may be used to determine the transit distance of the charged particle through each detector medium the charged particle passed through because the amount of energy deposited is directly proportional to the transit distance (i.e. the penetration depth) of the charged particle through the detector medium. The deposition of energy into the medium by the charged particle through the processes of ionization, scintillation radiation, Cherenkov radiation, braking radiation, thermal effects, phonon production, low-angle Coulomb scattering and combinations of these does not significantly alter the trajectory of the charged particle. The transit distance may then be used to determine the possible trajectories of the charged particle by geometrically fitting the transit distance within the confines of the detector medium's shape in every possible orientation that allows for both end points of the transit distance to lay on the surface of the detector medium. Alternatively, the amount of energy deposited in the detector medium may be used to determine the trajectory of the charged particle through each detector medium that the charged particle passes through, without determining the transit distance. For example, the trajectory of the charged particle through a detector medium may be determined by first measuring the amount of energy deposited therein and then cross-referencing that measured energy with a list that equates a given energy measurement to a specific trajectory (or group of trajectories) in relation to the pointing direction of the detector medium column. In this way, a DPD may measure the trajectory of a charged particle without actually determining the charged particle's transit length through the medium at all. In this embodiment, the creation of the list equating measured energies to deduced trajectories may be predetermined (as part of the design or calibration of the specific device). The electromagnetic energy measurement (in the form of an intensity measurement, power measurement, or equivalent measurement) may be converted or equated to a trajectory measurement by referencing a conversion list or reference table, or equivalent. This conversion list or reference table equates one or more measurements of electromagnetic energy (such as a power measurement, an intensity measurement, or equivalent measurement) to one or more charged particle trajectories for the specific DPD in question. This conversion list or reference table may be generated as part of the design and/or calibration of that specific DPD. This conversion list or reference table takes into account factors about the specific DPD, including, for example, the radius of the detector medium(s), the length of the detector medium(s), the material comprising the detector medium, the species of charged particle being detected, variations in the optical sensor(s), the signal propagation characteristics of the detector medium column, and/or other factors. A theoretical analysis or a computer simulation, such as a Monte Carlo simulation, may be used to determine the expected intensity (or power) deposited into a DPD by any charged particle at any energy and at any angle of incidence-this analysis or computer simulation may be used to produce the conversion list or reference table employed by the DPD. DPDs may not be required to derive the theoretical background about why a given energy measurement corresponds to a given charged particle trajectory (a DPD does not need to derive a transit length from the energy measurement and perform geometric fitting). Instead, all that the DPD may require is a conversion list or reference table that has been created for that specific DPD. The path-length derivation and geometric fitting required to equate a given electromagnetic energy measurement (in the form of an intensity, power or equivalent) to a resultant charged particle trajectory may be completed before the deployment of the DPD and may be provided in the form of a static conversion list or reference table.

A DPD may process or compute the theoretical background (path-length derivation and geometric fitting) of the charged particle detection event in real-time, or after the fact, or not at all. Such processing or computing may be obviated by using a conversion list or reference table that equates a measured energy to a trajectory.

The following is an illustrative, and not exhaustive, list of ways to characterize and/or quantify the “amount of energy” that is deposited by the charged particle into one or more detector mediums and which is measured by DPDs, which do not include photon counting.

As used herein, the phrase “energy measurement (such as a power measurement, intensity measurement, or any equivalent measurement)” is intended to encompass the following terms, without limitation:

### Flux (Radiant Flux)

Description: The total amount of energy (in the form of photons or electromagnetic waves) emitted, reflected, transmitted, or received by a surface per unit time.
Measurement: Measured using radiometric sensors that capture the total power across the spectrum.
Units: Watts (W)

### Flux Density (Spectral Flux Density)

Description: The amount of flux per unit area, often with an additional frequency or wavelength constraint.
Measurement: Typically measured by dividing the flux by the area over which it's distributed. Devices like photodiodes, phototransistors, CCDs, CMOS sensors, bolometers, and thermopiles measure flux density by converting the overall light intensity into an electrical signal without resolving individual photons (i.e. without counting photons).
Units: Watts per square meter (W/m²) or, when frequency-dependent, Watts per square meter per Hz (W/m²/Hz)

### Light Density (Luminance or Brightness)

Description: The perceived brightness or concentration of visible light per unit area.
Measurement: Measured using photometric instruments that match the human eye's sensitivity.
Units: Candelas per square meter (cd/m²)

### Power Density (Radiant Intensity)

Description: The amount of power per unit area, often across a specific spectrum.
Measurement: Calculated by dividing the power by the area, often in specific wavelengths.
Units: Watts per square meter (W/m²)

### Radiative Power (Radiant Power)

Description: The total energy emitted by a source in the form of electromagnetic radiation.
Measurement: Directly measured using radiometers or similar instruments that capture the total power output.
Units: Watts (W)

### Radiance Level

Description: The amount of radiant power emitted by a surface per unit solid angle per unit projected area.
Measurement: Measured by radiometers or spectroradiometers.
Units: Watts per square meter per steradian (W/m²/sr)

### Brightness (Photometric Brightness or Luminance)

Description: The visual perception of the intensity of light emitted or reflected from a surface.
Measurement: Typically measured with luminance meters or photometers.
Units: Candelas per square meter (cd/m²)

### Energy

Description: The total amount of work done or heat generated by a source, which can be in the form of light or other electromagnetic radiation.
Measurement: Can be measured using various calorimetric or photometric tools.
Units: Joules (J)

### Energy Density

Description: The amount of energy per unit volume.
Measurement: Often calculated by dividing the energy by the volume of interest.
Units: Joules per cubic meter (J/m³)

### Irradiance

Description: The amount of radiant flux received by a surface per unit area.
Measurement: Measured using irradiance meters or photometers.
Units: Watts per square meter (W/m²)

### Illumination (Illuminance)

Description: The perceived brightness or intensity of light falling on a surface.
Measurement: Measured with a lux meter.
Units: Lux (lx), equivalent to lumens per square meter (lm/m²)

### Light Level

Description: A general term describing the intensity of light in an environment.
Measurement: Can be measured using a light meter, depending on specific context.
Units: Typically lux (lx) for general lighting contexts

### Signal Strength

Description: The power or amplitude of a signal as received by a detector or sensor.
Measurement: Often measured with a signal analyzer or antenna.
Units: Decibels (dB) or Watts (W)

### Exposure

Description: The total amount of light (or other radiation) that a surface is exposed to over a specified time.
Measurement: Calculated by multiplying irradiance by the exposure time.
Units: Joules per square meter (J/m²)

### Exposure Level

Description: The cumulative amount of light or radiation received over a specified period.
Measurement: Measured using a photometric or radiometric detector.
Units: Often in lux-seconds or Joules per square meter (J/m²)

### Photometric Level

Description: A measurement of perceived light intensity by the human eye.
Measurement: Uses photometric sensors that mimic human visual sensitivity.

### Spectral Radiance

Description: Radiance per unit wavelength or frequency, detailing the intensity of radiation emitted by a surface.
Measurement: Measured using spectroradiometers tuned to specific wavelengths.
Units: Watts per square meter per steradian per nanometer (W/m²/sr/nm)

### Spectral Irradiance

Description: The radiant flux received by a surface per unit area per unit wavelength or frequency.
Measurement: Measured with spectroradiometers for wavelength-specific data.
Units: Watts per square meter per nanometer (W/m²/nm)

### Illuminant Power

Description: The power associated with a specific light source, irrespective of how it's distributed over an area.
Measurement: Typically measured by integrating the total radiant output.
Units: Watts (W)

### Luminous Flux

Description: The perceived power of light, adjusted for human visual response.
Measurement: Measured using photometric methods.
Units: Lumens (lm)

### Luminous Intensity

Description: The amount of light emitted in a particular direction by a source.
Measurement: Determined with photometric tools that account for directionality.
Units: Candelas (cd)

### Radiant Exitance

Description: The radiant flux emitted per unit area from a surface.
Measurement: Calculated from the radiant flux and emitting area.
Units: Watts per square meter (W/m²)

### Incident Energy Density

Description: The amount of energy impacting a surface per unit area.
Measurement: Calculated by integrating irradiance over time.
Units: Joules per square meter (J/m²)

### Incident Energy Density

Description: The amount of energy impacting a surface per unit area.
Measurement: Calculated by integrating irradiance over time.
Units: Joules per square meter (J/m²)

### Illuminating Power

Description: The total energy per unit time that a source emits as visible light.
Measurement: Often measured with a lux meter for photometric applications.
Units: Watts (W)

### Spectral Power Distribution

Description: The distribution of power per unit area per wavelength, characterizing the spectrum of a light source.
Measurement: Analyzed using spectrometers.
Units: Watts per square meter per nanometer (W/m²/nm)

### Radiant Emittance

Description: Radiant flux emitted from a surface per unit area.
Measurement: Calculated from the flux divided by the area.
Units: Watts per square meter (W/m²)

### Luminous Exposure

Description: The product of illuminance and time, describing cumulative light exposure.
Measurement: Measured by integrating illuminance over time.
Units: Lux-seconds (1x's)

### Photometric Flux

Description: The amount of light (adjusted for human vision) emitted by a source.
Measurement: Photometrically measured using a lux meter or similar.
Units: Lumens (lm)

### Radiometric Brightness

Description: Brightness quantified in radiometric terms, considering all radiation, not just visible light.
Measurement: Typically measured with a radiometer over a spectrum.
Units: Watts per square meter per steradian (W/m²/sr)

### Optical Power

Description: The power of light emitted by a source or transmitted through a medium.
Measurement: Measured directly with optical power meters.
Units: Watts (W)

Determining the amount of energy deposited into the detector medium may not require counting photons. Power and Intensity measurements (Watts) and energy measurements (Joules), for example, differ fundamentally from photon counting because the former measurements depend on both the number of photons and those photons' individual energies. Photon counting alone cannot determine the energy deposited by a charged particle into a detector medium because photon counting alone ignores the energy of each photon. Devices like photodiodes, phototransistors, CCDs, CMOS sensors, bolometers, and thermopiles (among others) measure flux density by converting the overall light intensity into an electrical signal without resolving individual photons (and therefore not by counting photons). The energy measurements found herein (such as a power measurement, an intensity measurement or an equivalent measurement) are fundamentally distinct from the photon counting measurement.

The transit length of the charged particle through the respective detector medium may be used to calculate the trajectory of the charged particle through the respective detector medium. For example, for elongated detector mediums, if the transit length equals the length of the detector medium, it may be inferred that the charged particle traveled parallel to the longitudinal axis of the detector medium. If the transit length is less than the length of the detector medium, it may be inferred that the charged particle trajectory was at an angle to the axis of the elongated detector medium. If the detector medium is substantially elongated in two spatial dimensions instead of one spatial dimension (planar instead of columnar) and the transit length of the charged particle through the detector medium is equal to the diameter of the detector medium plane, then it may be inferred that the charged particle traveled parallel to the major surfaces of the detector medium plane and through the center of the detector medium plane. If the transit length is less than the diameter of the detector medium plane, it may be inferred that the charged particle did not travel parallel to the major surfaces of the detector medium plane and also through the center point of the detector medium plane.

Similarly, the amount of energy deposited in the detector medium may be used to calculate the trajectory of the charged particle through the detector medium without determining the transit length. For example, the amount of energy deposited in the detector medium when a charged particle travels parallel to the length of the detector medium may be determined by theoretical means, experimental means or by some other process. If the amount of energy deposited in a one-dimensionally elongated detector medium from a charged particle passing therethrough (such as may be determined by an energy measurement) is equivalent or substantially equivalent to the amount of energy deposited in the detector medium when a charged particle travels parallel to the length of the detector medium, it may be inferred that the charged particle traveled parallel to the longitudinal axis of the detector medium. If the amount of energy deposited in the detector medium (the determined energy) is less than the amount of energy that is deposited in the detector medium when a charged particle travels parallel to the length of the detector medium, it may be inferred that the charged particle trajectory was at an angle to the longitudinal axis of the elongated detector medium. Two or more detection events taking place in two or more different DPDs, or different detector mediums within a composite DPD, may be correlated using the coincidence method.

An example system according to the disclosure may comprise at least one DPD or composite DPD operably coupled to a computing device 1001. The computing device 1001 may be configured to receive a signal generated by the at least one optical sensor 2. The signal generated by the at least one optical sensor 2 may correlate to the amount of energy deposited in a detector medium 1 from a charged particle 4 that passed through the detector medium 1. The computing device 1001 may determine, based on the received signal, at least one transit length of the charged particle. Each transit length is associated with a detector medium 1. Each transit length is proportional to the amount of energy deposited into the respective detector medium 1 from the reaction to the charged particle 4. The computing device 1001 may compare each transit length to the length of the respective detector medium 1 to determine the trajectory of the charged particle 4 with respect to the longitudinal axis 9 of the respective detector medium 1 that reacted to the charged particle 4. Alternatively, the computing device 1001 may determine, based on the received signal, the trajectory of the charged particle 4 with respect to the longitudinal axis 9 of the respective detector medium 1 that reacted to the charged particle 4 without determining the transit length. Optionally, the computing device 1001 may determine, based on the received signal, the trajectory 3 of the charged particle 4 with respect to the longitudinal axis 9 of the respective detector medium 1 based on the amount of energy deposited in a detector medium 1.

An example system according to the disclosure may comprise a plurality of DPDs 10, or optionally a plurality of composite DPDs 10, and a volume of matter 28. The system may be positioned to allow for charged particles to pass through the volume of matter 28 before passing through at least one of the DPDs or through at least one of the composite DPDs. In this example, one or more radiographs or one or more tomographs indicative of charged particle interaction with the volume of matter which is based on the trajectory of the charged particle that passed through the volume of matter and the DPD(s) or composite DPD(s) may be produced.

Optionally, the computing device 1001 may be configured to produce the one or more radiographs or the one or more tomographs indicative of charged particle interaction with the volume of matter 28 and based on the trajectory of the charged particle that passed through the volume of matter and the DPD(s) or composite DPD(s). In an example embodiment, a plurality of DPDs 10, optionally one or more composite DPDs 10, may be positioned such that a charged particle may pass through at least one DPD 10 or composite DPD 10 before passing through the volume of matter 28 and then pass through at least one other DPD 10 or composite DPD 10 after passing through the volume of matter 28. The trajectory of the charged particle before passing through the volume of matter 28 and the trajectory of the charged particle after passing through the volume of matter 28 may be compared to characterize the volume of matter 28. In this example, the trajectory of charged particle through at least one DPD 10 or composite DPD 10 before the charged particle passes through the volume of matter 28 and the trajectory of the charged particle through the at least one DPD 10 or composite DPD 10 after the charged particle passes through the volume of matter 28 may be compared to determine if the charged particle was scattered during transit through the volume of matter. Optionally, the computing device 1001 may be configured to compare the trajectory of the charged particle through at least one DPD 10 or composite DPD 10 before the charged particle passes through the volume of matter and the trajectory of the charged particle through the at least one DPD or composite DPD after the charged particle passes through the volume of matter to determine if the charged particle was scattered during transit through the volume of matter. Optionally, the angle by which the detected charged particle was scattered may be determined via the computing device 1001. One or more charged particle radiographs or one or more charged particle tomographs indicative of charged particle interaction with the volume of matter based on the charged particle passing through one or more DPD or composite DPD before passing through the volume of matter and passing through one or more DPD or composite DPD after passing through the volume of matter may be produced. Optionally, the computing device 1001 may be configured to produce the one or more radiographs or the one or more tomographs indicative of charged particle interaction with the volume of matter based on the charged particle passing through one or more DPD 10 or one or more composite DPD 10 before passing through the volume of matter 28 and passing through one or more DPD 10 or one or more composite DPD 10 after passing through the volume of matter 28.

In accordance with the disclosure, the problem of characterizing the internal composition of a volume of matter may be solved by synthesizing, optionally via the computing device, the output of one or more DPD or composite DPD and calculating radiographs or tomographs indicative of charged particle interaction with the volume of matter. The types of charged particle interactions with the volume of matter may include transmission, absorption, scattering, annihilation, decay, nuclear interactions, electromagnetic interactions, or collective effects like phonon, polariton or plasmon interactions.

Throughout this disclosure, the term “fluid” is defined broadly to include not only classical gases and liquids but also plasmas and superfluids. Likewise, the term “solid” is defined to include both classical solids and supersolids.

One advantage of one or more aspects of the present disclosure over prior art is that the processing of output signals from one or more DPDs or composite DPDs is relatively straightforward as compared to the processing of output signals from a coincidence method detector array. The data processing of DPD or composite DPD output signals is relatively simple because no coincidence logic is required. This is true because each detector medium's maximal output signal corresponds to a single charged particle trajectory (and its 180-degree opposite trajectory). Because coincidence analysis is not required by one or more aspects of the present disclosure, cost and size may be reduced while physical robustness, angular resolution and speed of imaging may be improved as compared to known systems and methods for determining charged particle trajectory. Further, because a composite DPD comprises a plurality of detector mediums, a composite DPD may provide direct trajectory measurements of charged particle flux in multiple directions. By contrast, the coincidence method requires a computer system to calculate the direction of incident charged particles from the relative position and timing of two or more charged particle detection events.

In accordance with the disclosure, variations in the maximal angular resolution of a DPD may result from variations in the length to width aspect ratio of its detector mediums. In addition, the angular resolution of a composite DPD is related to the angular separation of the axis directions of its constituent detector mediums (or constituent DPDs). Similarly, in accordance with the disclosure, variations in the effective angular resolution of a composite DPD may result from variations in the amplitude threshold(s) that is applied to the output signal(s) of one or more the optical sensor(s), such as by a controller or a computer or an electrical component.

What follows is a comparison of the reported angular resolution capabilities of two prior art borehole coincidence arrays to the angular resolution capability of a single example DPD for deployment in a borehole in the interest of muography. For the sake of illustration, this example DPD is not composite DPD, but is a single detector medium affixed to a single optical sensor (a non-composite DPD).

Conventional coincidence method borehole muon detector arrays are known to have angular resolutions of about 0.67 degrees in the azimuth and about 3.1 degrees in the zenith. Other conventional coincidence method borehole muon detector arrays are known to have angular resolution of about 0.57 degrees in all directions.

In this comparison, an example DPD comprises a single detector medium column which is a scintillating fiber with a radius chosen to be 0.1 mm and a length chosen to be 75 mm is optically coupled to an inexpensive uv-photodiode. 75 mm is similar to the diameter of a standard mining borehole and, therefore, a DPD of that length can be placed in any orientation within a standard mining borehole. If this specific DPD is calibrated to output a signal only when a charged particle traverses the full length of the scintillating fiber, this length to width aspect ratio equates to an angular resolution of 0.15 degrees—a significant improvement over conventional coincidence borehole detectors. This angular resolution was determined by applying the geometric angular acceptance formula, Δθ=2arctan(R/L), where R is the radius of the detector medium columns (0.1 mm in this instance) and L is the length of the detector medium column (75 mm in this instance). This formula was derived for use with the coincidence method, but it can be used in approximating the maximal angular resolution of a DPD because we can equate the detector medium column comprising the DPD to two detectors that have the same surface areas as the cross-sections of the detector medium column at either end of the detector medium column and which are separated by a distance equal to the length of the detector medium column.

By way of example, a DPD deployed in a borehole may be substantially longer than 75 mm if the constituent detector medium column(s) are somewhat parallel to the vertical axis of the borehole (which is a favorable flux direction for borehole muography because atmospheric muon flux is strongest at the vertical, and because many boreholes are drilled near the vertical). For example, a DPD similar to that described in the above calculation but with a radius of 0.1 mm and a length of 2 meters, which is tilted slightly off of the vertical axis of a borehole, would exhibit a maximal angular resolution of 0.0057 degrees (a 100-fold improvement in angular resolution as compared to the angular resolution of prior art coincidence method borehole detectors). Reducing the diameter of the detector medium of the DPD (while maintaining the length of the detector medium column) would also increase the maximal angular resolution of the DPD beyond that calculated above. Similarly, further increasing the length of the detector medium of the DPD (while maintaining the diameter of the detector medium column) would also increase the maximal angular resolution of the DPD beyond that calculated above.

In the borehole muography application of one or more aspects of the present disclosure, a larger vertical extent of the boreholes may be instrumented with detectors due to the low cost of DPDs as compared to known devices. This may increase the number of viewing angles of the detectors (or reduce the “distance” between perspectives), improving the system's ability to perceive and resolve the internal structure of the volume of matter under inspection.

Another advantage of one or more aspects of the disclosed subject matter over the prior art is the fact that it can be readily miniaturized in diameter or in length. The coincidence method, by comparison, is resistant to minaturization due to the time comparison requirements of the coincidence method.

In the field of proton therapy, the reduced cost to determine the trajectory of a proton, the improved angular resolution of that trajectory determination, as well as the ability to make real-time measurements (advantages that are all made possible by one or more aspects of the present disclosure) may result in significantly enhanced treatment precision, enabling more targeted tumor irradiation with minimal damage to surrounding healthy tissue, while potentially lowering overall costs for healthcare providers.

In the field of ion implantation in chip manufacture, the reduced cost to determine the trajectory of a ion, the improved angular resolution of that trajectory determination, as well as the ability to make real-time measurements (advantages that are all made possible by one or more aspects of the present disclosure) may result in more uniform doping across semiconductor wafers, higher yield rates, and minimized production costs, as real-time data on ion trajectories enable more precise adjustments during implantation. This may lead to significantly improved device performance, with tighter control over doping profiles and reduced risk of chip defects.

In the field of cargo scanning via muography, the reduced cost to determine the trajectory of muons, the improved angular resolution of that trajectory determination, as well as the ability to make real-time measurements (advantages that are all made possible by one or more aspects of the present disclosure) may result in more reliable and efficient inspection processes at ports and border checkpoints, as well as wider adoption of such systems.

In the field of nuclear physics experimentation involving heavy-ion collisions, the reduced cost to determine the trajectory of ions, the improved angular resolution of that trajectory determination, as well as the ability to make real-time measurements (advantages that are all made possible by one or more aspects of the present disclosure) may result in enhanced insight into nuclear structure and reaction dynamics. By precisely tracking scattered and secondary charged particles with minimal reliance on complicated coincidence circuitry, researchers may be able to map out interaction vertices more accurately, shedding new light on exotic isotopes and the limits of nuclear stability.

In the field of electron beam additive manufacturing, the reduced cost to determine the trajectory of electrons, the improved angular resolution of that trajectory determination, as well as the ability to make real-time measurements (advantages that are all made possible by one or more aspects of the present disclosure) may result in higher fidelity layer-by-layer fabrication with minimal waste. By instantly adjusting the beam path based on precise feedback, manufacturers may be able to achieve more intricate geometries and tighter tolerances in metal 3D-printed components.

In the field of electron beam welding for aerospace manufacturing, the reduced cost to determine the trajectory of electrons, the improved angular resolution of that trajectory determination, as well as the ability to make real-time measurements (advantages that are all made possible by one or more aspects of the present disclosure) may result in stronger, lighter, and more reliable joints in critical aerospace components. By providing instant feedback on beam focus and position, production lines can quickly adjust welding parameters to accommodate material irregularities or temperature fluctuations. This may yield higher quality control and reduced scrap rates, driving down costs.

In the field of advanced radiography for industrial applications, the reduced cost to determine the trajectory of charged particle beams, the improved angular resolution of that trajectory determination, as well as the ability to make real-time measurements (advantages that are all made possible by one or more aspects of the present disclosure) may result in quicker, more detailed inspections of critical structures like pipelines, aircraft components, and high-pressure vessels. By enabling fine-grained imaging of internal features, one or more aspects of the present disclosure may reduce downtime, enhance maintenance predictability, and help prevent catastrophic failures.

In the field of Positron Emission Tomography (PET) scans, the reduced cost to determine the trajectory of a positron, the improved angular resolution of that trajectory determination, as well as the ability to make real-time measurements (advantages that are all made possible by one or more aspects of the present disclosure) may result in real-time beam monitoring, enhanced imaging accuracy, improved patient safety, broader clinical adoption and better overall treatment outcomes. By empowering on-the-fly adjustments to positron beam trajectories, one or more aspects of the present disclosure may minimize radiation dosage, reduce overall procedure time, and facilitate faster patient throughput.

In the field of positron annihilation spectroscopy (PAS) for materials science, the reduced cost to determine the trajectory of positrons, the improved angular resolution of that trajectory determination, as well as the ability to make real-time measurements (advantages that are all made possible by one or more aspects of the present disclosure) may result in a more detailed analysis of material defects at the atomic level.

In the field of nuclear fusion reactor development, the reduced cost to determine the trajectory of plasma ions, the improved angular resolution of that trajectory determination, as well as the ability to make real-time measurements (advantages that are all made possible by one or more aspects of the present disclosure) may result in significantly enhanced reactor diagnostics and control. By more accurately tracking the behavior of charged particles in fusion plasmas, engineers may be able to further fine-tune magnetic confinement parameters and optimize reactor stability.

In the field of high-precision neutron generation (via proton bombardment), the reduced cost to determine the trajectory of protons, the improved angular resolution of that trajectory determination, as well as the ability to make real-time measurements (advantages that are all made possible by one or more aspects of the present disclosure) may result in more reliable and tunable neutron sources. While one or more aspects of the present disclosure does not track neutrons directly, it may greatly refine the control of proton beams that produce them, improving neutron yield consistency and reducing excess radiation or waste. Neutron sources find application across medicine, materials testing, and nuclear security.

In the field of carbon-ion therapy, the reduced cost to determine the trajectory of carbon ions, the improved angular resolution of that trajectory determination, as well as the ability to make real-time measurements (advantages that are all made possible by one or more aspects of the present disclosure) may result in a more effective treatment modality for complex tumors.

In the field of muon tomography for geological and structural analysis, the reduced cost to determine the trajectory of naturally occurring muons, the improved angular resolution of that trajectory determination, as well as the ability to make real-time measurements (advantages that are all made possible by one or more aspects of the present disclosure) may result in more detailed, faster and cheaper imaging of subjects.

In the field of mass spectrometry, the reduced cost to determine the trajectory of ionized samples, the improved angular resolution of that trajectory determination, as well as the ability to make real-time measurements (advantages that are all made possible by one or more aspects of the present disclosure) may result in more sensitive and efficient detection of molecular species. By facilitating high-precision ion tracking and by reducing dependence on complicated coincidence circuits, laboratories can process larger sample volumes faster, at lower operational costs.

In the field of proton radiography for industrial quality control, the reduced cost to determine the trajectory of protons, the improved angular resolution of that trajectory determination, as well as the ability to make real-time measurements (advantages that are all made possible by one or more aspects of the present disclosure) may result in faster, more detailed imaging of large or dense objects such as turbine blades, reactor parts, and structural components.

In the field of quantum computing component fabrication, the reduced cost to determine the trajectory of ions used for qubit doping, the improved angular resolution of that trajectory determination, as well as the ability to make real-time measurements (advantages that are all made possible by one or more aspects of the present disclosure) may result in superior device performance and yield. By ensuring precise implantation of dopants into superconducting circuits or semiconductor qubits, researchers and manufacturers may achieve tighter control over quantum states, thereby enhancing coherence times and gating fidelity.

In the field of advanced scanning electron microscopy (SEM), the reduced cost to determine the trajectory of electrons, the improved angular resolution of that trajectory determination, as well as the ability to make real-time measurements (advantages that are all made possible by one or more aspects of the present disclosure) may result in unparalleled imaging clarity and throughput. By refining electron-beam targeting, researchers and manufacturers can capture higher-resolution images faster.

In the field of ion thruster propulsion for satellites and deep-space missions, the reduced cost to determine the trajectory of ions, the improved angular resolution of that trajectory determination, as well as the ability to make real-time measurements (advantages that are all made possible by one or more aspects of the present disclosure) may result in more efficient and precisely controlled propulsion systems. By tracking and adjusting ion beam paths with far greater accuracy, satellite maneuvers and long-duration spacecraft trajectories can be optimized to conserve fuel, reduce cost and extend operational lifetimes.

One or more aspects of the present disclosure can find application in mining, archaeology, civil engineering, manufacturing, hydrology, geology, meteorology, border security, aerospace engineering, maritime engineering, medical imaging and therapy, advanced materials research, recycling, energy systems, high-energy physics, quantum technologies, subterranean and space exploration, infrastructure monitoring, and a wide range of related domains.

The target of interest (volume of matter under inspection) of one or more aspects of one or more embodiments may be any geological formation (such as ore deposits, fluid reservoirs, volcanoes, faults, soil, gas fields, oil fields, caves, voids, mineral occurrences, geothermal reservoirs, geological resources, mountains, hills or overburden), large-scale infrastructure (such as mines, pipelines, dams, bridges, levees, tunnels, telecommunication hardware or electricity distribution hardware), industrial facilities (such as blast furnaces, refineries, nuclear reactors, power plants, waste repositories, leach piles, nuclear waste receptacles or landfills), biological or medical systems (such as tissues, organs, implants, medical devices, genetic samples, medical equipment or production lines), lifeforms, electronics, advanced materials and devices (such as semiconductors, microelectronics, composites, quantum computing substrates, or spintronic architectures), manufacturing and assembly lines, transportation vehicles (such as ships, trains, airplanes, helicopters, rockets, or drones), energy systems (such as batteries or fuel cells), major structures (such as buildings, underground facilities, or foundations), environmental or natural features (such as water columns, glaciers, icebergs, ice sheets, permafrost, pingos, reefs, burrows, atmosphere, clouds, or storms), packaging, artwork, rare-earth or mineral processing sites, heavy machinery assemblies, vaults, containers such as shipping containers, cargo, freight, space-based assets (such as satellites or orbital debris), subterranean assets (such as buried treasure or landmines), defense or security-related targets (such as ballistic plates or protective enclosures), advanced recycling or e-waste recovery lines, marine resources, robotic components, metamaterial or 2D-material doping lines, archaeological sites or materials, paleontological sites or materials, environmental remediation sites, quantum material growth or testing lines, photovoltaics, turbines and any related objects or combinations thereof.

### EXAMPLE EMBODIMENTS

The parameters of these embodiments are illustrative, and are not therefore to be taken as a limit upon the present disclosure. Persons skilled in the art will be aided by the teachings herein to adapt the principles of the present disclosure to other embodiments.

### Embodiment 1: Method for Measuring the Trajectories of Charged Particles

A first embodiment of the disclosure is a method for measuring the trajectories of charged particles using one or more DPDs. At least some of the DPDs are capable of detecting the direction of an incident charged particle from a single charged particle detection event. A charged particle detection event is an interaction between a charged particle and a charged particle detector. More specifically, this embodiment does not require a computing device but one may be added. The method may comprise determining the transit length of a charged particle's trajectory within a detector medium. The method may further comprise equating the transit length to one or more possible trajectories of the charged particle. The method may further comprise synthesizing the charged particle trajectory measurements into one or more charged particle radiographs or one or more charged particle tomographs (not pictured).

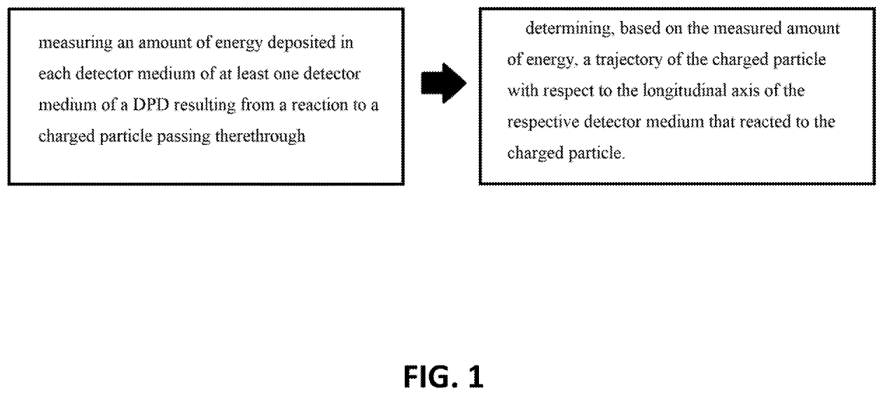

As shown in FIG. 1, the method may comprise measuring an amount of energy deposited in each detector medium of at least one detector medium of a DPD resulting from a reaction to a charged particle passing therethrough. The method also comprises determining, based on the measured amount of energy, a trajectory of the charged particle with respect to the longitudinal axis of the respective detector medium that reacted to the charged particle. Optionally, the measured amount of energy may be used to determine a transit length of the charged particle through each detector medium to determine the trajectory of the charged particle. The method may further comprise synthesizing the charged particle trajectory measurements into one or more charged particle radiographs or one or more charged particle tomographs.

### Embodiment 2: Composite DPDs

With reference to FIGS. 6, 7, 8, 9, and 10, a composite DPD 10 comprises a plurality of detector medium columns 12 in close proximity to each other, with the axes of the constituent detector medium columns (or the constituent DPDs) oriented in one or more directions. In some embodiments, one or a small number of optical sensors or one or more composite optical sensors 14 such as CCD or CMOS array sensors can remotely monitor many or all of the detector medium columns that make up a composite DPD.

Composite DPDs 10, illustrated in FIGS. 6, 7, 8, 9, and 10 provide directional measurements of charged particles in the axis direction of each detector medium 1 of the plurality 12 of detector mediums. Decreasing the angular spacing between the axis directions of the constituent detector medium columns 12 increases the maximal angular resolution of the composite DPD 10 up to a limit which is determined by the length to width aspect ratio of the constituent detector medium columns 12.

In FIGS. 6 and 7, the detector medium columns 1 are shaped like frustums of cones in order to maximize the packing density of the detector medium columns 1 of the composite DPD 10 in those arrangements. Frustums with cross sections which can be tessellated (triangles, squares, hexagons, etc) may achieve higher packing densities.

Disclosed herein are five examples of different geometries/arrangements of composite DPDs. This is an illustrative list, not an exhaustive list, and should not be interpreted to constrain the breadth of embodiments covered by this application.

FIG. 6: A composite DPD with a “Porcupine” arrangement.

In this embodiment, a plurality of detector medium columns 12 of a composite DPD 10 have axis directions which span a substantial (or full) azimuthal angular range and which also span a substantial (or full) zenith angular range with respect to a spherical coordinate system.

One or more optical sensors 14 may be in communication with many or all of the detector medium columns (which are shaped like frustums of cones) through an air gap or by one or more optical components (optical component not depicted).

In FIG. 6, less than one hemisphere is instrumented with detector medium columns/frustums in order to more clearly illustrate the arrangement.

FIG. 7: A composite DPD with a “Stack of Fans” arrangement.

In this embodiment, a plurality of detector medium columns 12 of a composite DPD 10 exhibit axis directions which span a substantial (or full) angular range in one coordinate direction, but which span only a small (or null) angular range in another coordinate direction with reference to a spherical coordinate system. Each such group of detector medium columns 12 resembles a “fan” (with each such fan spanning the full 360-degrees azimuthal but with each detector medium column within each fan pointing at the same or nearly the same zenith angle).

FIG. 7 shows six such “fans” of detector medium columns 12 that are arranged in layers around a central support structure which houses the optical sensor(s) 14 and any optional optical elements (optical elements are not depicted in FIG. 7). Each “fan” comprises a plurality of detector medium columns which, taken together, substantially cover the full 360-degrees of azimuth. The detector medium columns 12 are shaped like frustums of cones in order to increase the packing density of the detector medium columns 12 of the composite DPD 10 (thereby increasing the rate of detection events in the composite DPD 10 without affecting its external volume).

This embodiment can be raised or lowered in relation to a volume of matter or a target of interest (such as raised or lowered in a mining borehole) in order to image a full three-dimensional volume of matter.

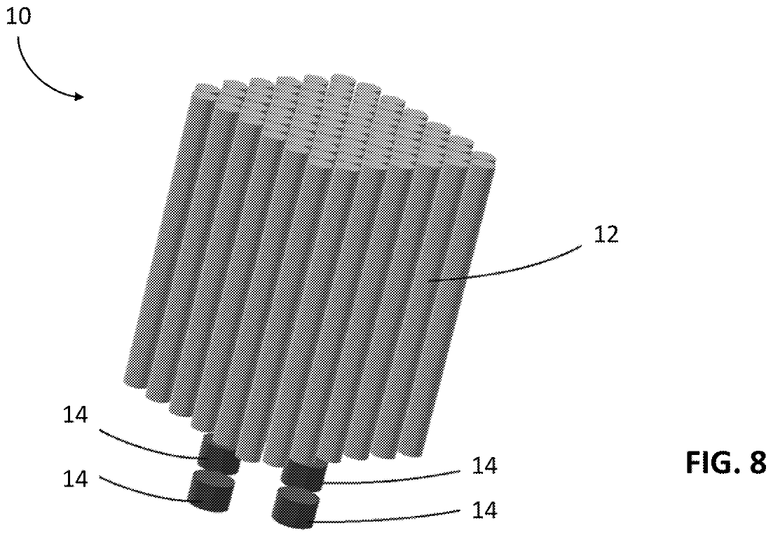

FIG. 8: A composite DPD with a “Unidirectional” arrangement.

In this embodiment, a plurality of detector medium columns 12 comprising a composite DPD 10 exhibits substantially parallel axis directions. The plurality is monitored remotely by one or more optical sensors 14 (alternatively, the detector medium columns 12 may be monitored directly by optical sensors 14).

As compared to a monitoring a single detector medium column, monitoring a plurality of equivalent detector medium columns 12 increases the detected charged particle flux.

In FIG. 8, the detector medium columns 12 are parallel-walled columns (cylinders), but detector medium columns shaped like frustums of cones or frustums of pyramids or any other shape that is substantially elongated in a single spatial dimension may also be employed in a “unidirectional” arrangement. Similarly, the detector medium columns 12 in FIG. 8 exhibit circular cross sections, but detector medium columns that exhibit polygonal cross sections (which can be tessellated) may also be used, as can detector medium columns of any cross sectional shape.

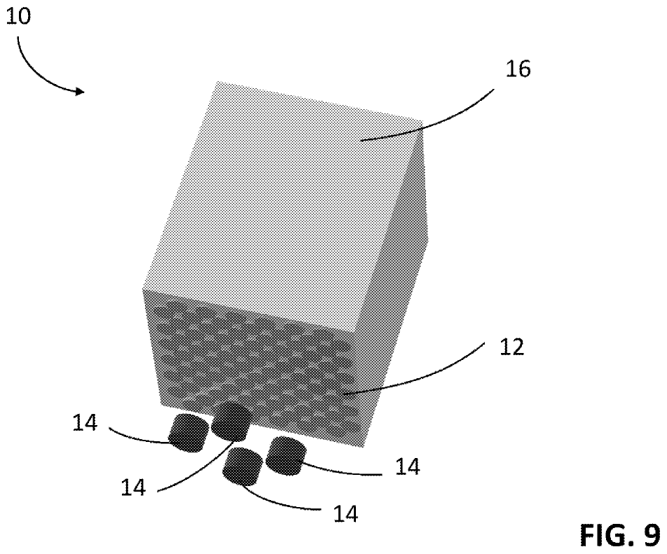

FIG. 9: A composite DPD with its constituent detector medium columns in “unidirectional” arrangement with detector medium column boundaries formed from a block 16 of reflective material (or, alternatively, a block of non-reflective material exhibiting a reflective coating).

The block's columnar vacancies are filled with fluid detector medium or solid detector medium-each columnar vacancy in the block becomes a detector medium column 12 once filled with detector medium. The detector medium columns 12 are monitored by one or more optical sensors 14. In FIG. 9, the optical sensors 14 are remotely coupled to the plurality of detector medium columns 12 by an air gap (alternatively, the detector medium columns 12 may be monitored directly by one or more optical sensor 14).

For this and other embodiments in which the reflective boundaries enclosing one or more detector medium columns are formed from a block of material, detector medium columns with cross sections that can be tessellated (such as triangular, square or hexagonal cross sections) may be preferred over detector medium columns with circular cross sections (which cannot be tessellated), provided that the manufacturing cost is acceptable. This may be preferred because when detector medium columns exhibit cross-sections that can be tessellated, the “empty space” between the detector medium columns is minimized, and the detector medium volume is maximized.

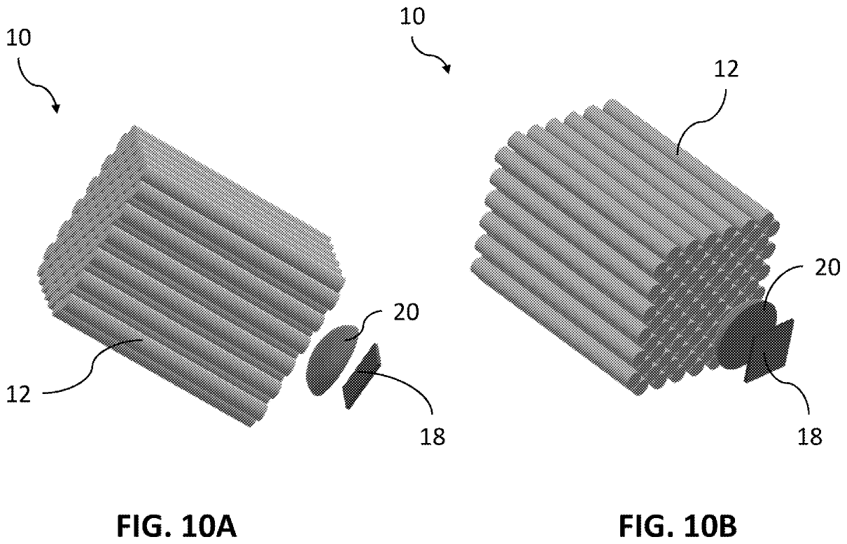

FIG. 10 depicts a composite DPD 10 with a “unidirectional” arrangement that utilizes a planar array of photodetectors 18, such as an array of CMOS or CCD detectors, to monitor a plurality of detector medium columns 12. The embodiment is depicted with an optical element 20 (in this case a lens, but alternatively a diffraction grating, a filter, an aperture, or some other optical element) which is used to collimate or otherwise optically condition the photons emanating from the detector medium columns 12 for reception by the optical sensor(s). The inclusion of the optical element is optional.

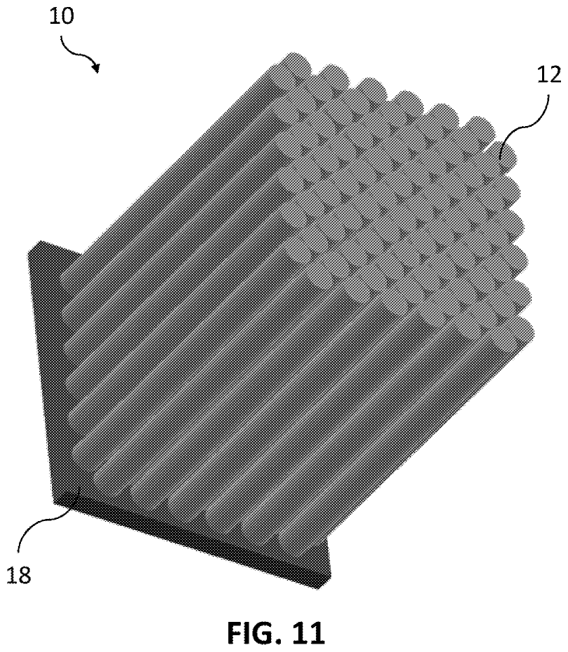

FIG. 11 depicts a composite DPD 10 with a “unidirectional” arrangement wherein each constituent detector medium column 12 is directly affixed to a planar array of optical sensors 18, such as an array of CMOS or CCD detectors. Optionally, waveguides (such as fiber optics) may be used to optically couple one or more detector medium columns 12 to one or more optical sensor of the CMOS or CCD (or other) detector array 18, instead of affixing them directly as depicted in FIG. 11. Such coupling waveguides (which are not depicted in FIG. 11) may allow for a reduction in the cross-sectional diameter of the waveguide from the diameter of the detector medium column's to the diameter of one or more optical sensors comprising the CMOS or CCD detector array.

### Embodiment 3:“Transmission Tomography”

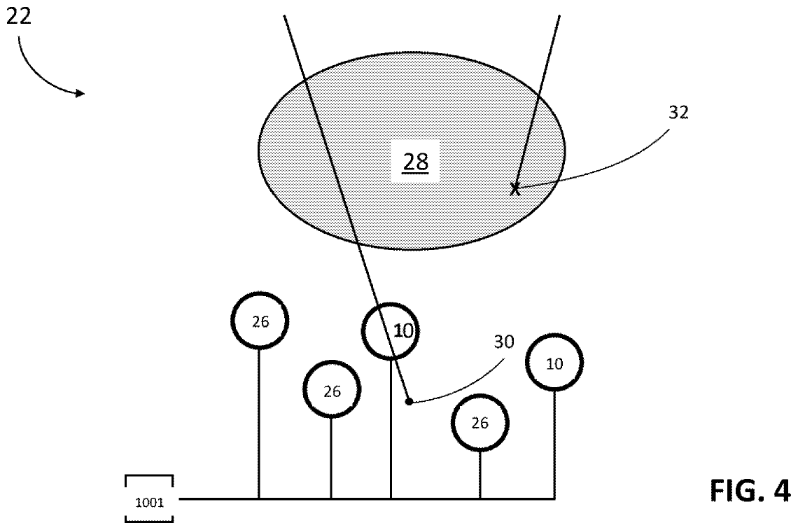

FIG. 4 depicts a third embodiment of the present disclosure: a system 22 for charged particle tomography or charged particle radiography comprising a computer device 1001 in communication with a plurality of charged particle detectors 26, with at least some of the charged particle detectors capable of detecting the direction of an incident charged particle from a single charged particle detection event (that is, with at least some of these charged particle detectors being DPDs 10). The volume of matter 28 under inspection is monitored by DPDs 10 which are placed below (or behind) the volume of matter 28 under inspection (so that the charged particle must pass through the volume of matter under inspection before detection by the DPDs). Each DPD 10 detects transmitted charged particles 30, and can thereby deduce the absence of charged particles 32 from an expected charged particle flux through traditional tomographic techniques. The computer device 1001 receives the output from the DPDs 10 and processes these into a model (such as a tomograph or a radiograph) which is representative of the internal composition of the volume of matter 28.

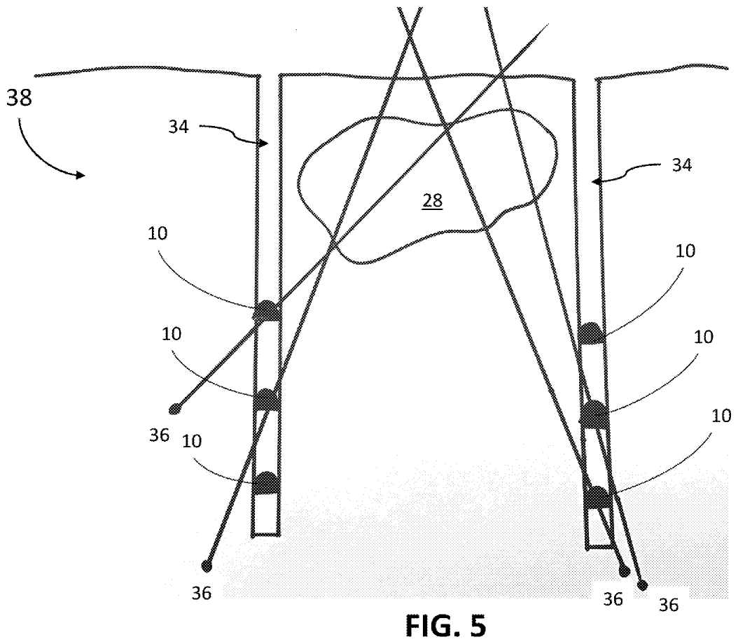

FIG. 5 is a pictorial figure showing an ore body under examination, with 6 DPDs or composite DPDs 10 (optionally, in “porcupine” arrangements) which are placed in two boreholes 34, and four incident cosmic ray muons 36.

By measuring muon flux variations at different angles and locations, the system 38 can synthesize one or more muon tomographs or muon radiographs which are representative of the internal composition of the target of interest (an ore body).

Systems 38 according to this embodiment may be used in mining, archaeology, civil engineering, manufacturing industry, hydrology, geology, or border security. The target of interest (volume of matter under inspection) of one or more aspects of the present embodiment may be any geological formation (such as ore deposits, fluid reservoirs, volcanoes, faults, soil, gas fields, oil fields, caves, voids, mineral occurrences, geothermal reservoirs, geological resources, mountains, hills or overburden), large-scale infrastructure (such as mines, pipelines, dams, bridges, levees, tunnels, telecommunication hardware, or electricity distribution hardware), industrial facilities (such as blast furnaces, refineries, nuclear reactors, power plants, waste repositories, leach piles, nuclear waste receptacles, or landfills), lifeforms, major structures (such as buildings, underground facilities, or foundations), environmental or natural features (such as water columns, glaciers, icebergs, ice sheets, permafrost, pingos, reefs, burrows, atmosphere, clouds, or storms), rare-earth or mineral processing sites, vaults, containers such as shipping containers, cargo, freight, subterranean assets (such as buried treasure or landmines), defense or security-related targets (such as ballistic plates or protective enclosures), marine resources, archaeological sites or materials, paleontological sites or materials, environmental remediation sites, and any related objects or combinations thereof.

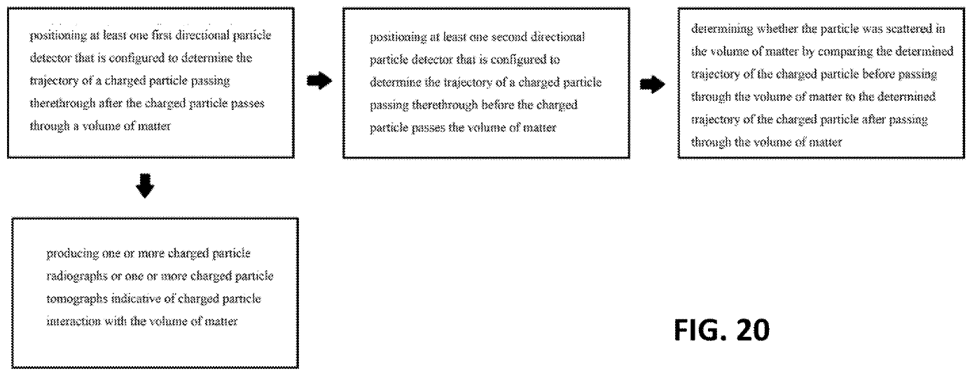

As shown in FIG. 20, a method of producing radiographs and/or tomographs may comprise positioning at least one first directional particle detector that is configured to determine the trajectory of a charged particle passing therethrough after the charged particle passes through a volume of matter. The method may also comprise producing one or more charged particle radiograph or one or more charged particle tomographs indicative of charged particle interaction with the volume of matter.

### Embodiment 4:“Scattering Tomography Using DPDs and Coincidence Method”

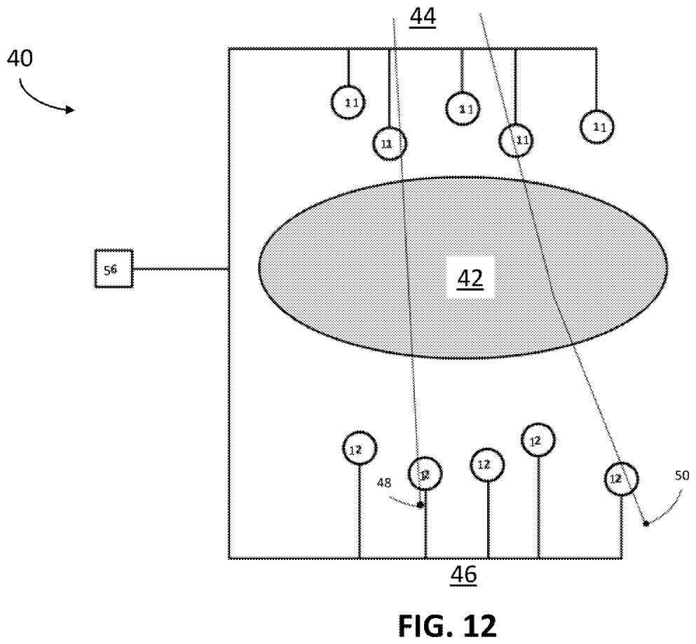

FIG. 12 shows a system 40 that relies on detecting charged particle scattering. Systems 40 that rely on measuring charged particle scattering require at least one DPD or composite DPDs 11 on each of at least two sides of a target of interest 42. One side is the side of incidence of charged particles 44 before entering the target. Detectors 26 on the side of incidence 44 detect the trajectory of charged particles prior to passing through the target 46. Detectors 12 on the other side or sides of the target of interest 46 measure the trajectories of charged particles exiting the target of interest after having been transmitted through the target of interest 48 or scattered by the target of interest 50.

A data processing system 56 applies the coincidence method to the signals from the incident side detectors 11 and the exit side detectors 12, and for those coincident charged particle detection events calculates if the charged particle was transmitted by 48 or scattered by 50 the target of interest. If the charged particle was scattered 50, the system 40 may determine the location within the target of interest 42 where scattering occurred and, optionally, may calculate the angle of scattering, a range of angles of scattering, an upper limit on the angle of scattering, or a lower limit on the angle of scattering.

Existing systems to achieve charged particle scattering measurements (those that do not employ DPDs) have two layers of detectors on the incidence side of the target of interest and two layers of detectors on the exit side of the target of interest. These prior art systems apply the coincidence method three times: first for charged particle detection events of the two layers of detectors on the incidence side to determine the trajectory of an incident charged particle; second for charged particle detection events for the two layers of detectors on the exit side to determine the trajectory of an exiting charged particle; third to determine if incident and exiting charged particle detection events were caused by the same charged particle. Thus, using DPDs or composite DPDs as described in this embodiment reduces the minimum number of detectors required for a charged particle scattering system from four (in the case of prior art, with two on the incident side and two on the exit side) to just two (one on the incident side and one on the exit side) and reduces the number of applications of the coincidence method from three to one, saving cost and complexity.

One or more aspects of the present embodiment can find application in mining, archaeology, civil engineering, manufacturing, hydrology, geology, meteorology, border security, aerospace engineering, maritime engineering, medical imaging and therapy, advanced materials research, recycling, energy systems, high-energy physics, quantum technologies, subterranean and space exploration, infrastructure monitoring, and a wide range of related domains.

The target of interest (volume of matter under inspection) of one or more aspects of one or more embodiments may be any geological formation (such as ore deposits, fluid reservoirs, volcanoes, faults, soil, gas fields, oil fields, caves, voids, mineral occurrences, geothermal reservoirs, geological resources, mountains, hills or overburden), large-scale infrastructure (such as mines, pipelines, dams, bridges, levees, tunnels, telecommunication hardware or electricity distribution hardware), industrial facilities (such as blast furnaces, refineries, nuclear reactors, power plants, waste repositories, leach piles, nuclear waste receptacles or landfills), biological or medical systems (such as tissues, organs, implants, medical devices, genetic samples, medical equipment or production lines), lifeforms, electronics, advanced materials and devices (such as semiconductors, microelectronics, composites, quantum computing substrates, or spintronic architectures), manufacturing and assembly lines, transportation vehicles (such as ships, trains, airplanes, helicopters, rockets, or drones), energy systems (such as batteries or fuel cells), major structures (such as buildings, underground facilities, or foundations), environmental or natural features (such as water columns, glaciers, icebergs, ice sheets, permafrost, pingos, reefs, burrows, atmosphere, clouds, or storms), packaging, artwork, rare-earth or mineral processing sites, heavy machinery assemblies, vaults, containers such as shipping containers, cargo, freight, space-based assets (such as satellites or orbital debris), subterranean assets (such as buried treasure or landmines), defense or security-related targets (such as ballistic plates or protective enclosures), advanced recycling or e-waste recovery lines, marine resources, robotic components, metamaterial or 2D-material doping lines, archaeological sites or materials, paleontological sites or materials, environmental remediation sites, quantum material growth or testing lines, photovoltaics, turbines and any related objects or combinations thereof.

As shown in FIG. 20, a method of determining whether a particle was scattered in a volume of matter may comprise positioning at least one first DPD that is configured to determine the trajectory of a charged particle passing therethrough after the charged particle passes through a volume of matter. The method may also comprise positioning at least one second DPD that is configured to determine the trajectory of a charged particle passing therethrough before the charged particle passes the volume of matter. The method may comprise determining whether the particle was scattered in the volume of matter by comparing the determined trajectory of the charged particle before passing through the volume of matter to the determined trajectory of the charged particle after passing through the volume of matter.

### Embodiment 5:“Coincidence Logic for Improved Angular Resolution of Somewhat-Off-Axis Charged Particles”

In principle, a DPD can detect the interaction of a charged particle with its elongated detection medium regardless of the charged particle's trajectory (as long as the charged particle intersects the detector medium). A charged particle that traverses the entire length of the detection medium will produce the strongest response (the greatest amount of deposited energy) in the detector and can be assumed to have a trajectory that is parallel to the direction of the detector medium's axis. A charged particle trajectory that is not parallel to the direction of the detector medium column's axis will produce a weaker response (a lesser amount of deposited energy) because of its reduced transit length through the detection medium as compared to the on-axis charged particle. Each detection event that corresponds to a charged particle transit length through the detector medium column which is shorter than the length of the detector medium column does not, by itself, contain enough information to determine the full trajectory of the charged particle unambiguously. Instead, such sub-maximal detection events each correspond to a range of possible trajectories. However, especially in a composite DPD 10 in which the constituent DPDs or the constituent detector medium columns 12 are spaced close together, it is possible that a somewhat-off-axis charged particle (for example, a charged particle 5-degrees off of the longitudinal axis of the detector medium column) will transit the detection medium of more than one of the constituent DPDs or of more than one constituent detector medium columns of a composite DPD, creating multiple charged particle detection events in contiguous detector medium columns. In such a case, the spatial relationship of the multiple detection events may give additional information about the trajectory of the somewhat-off-axis charged particle.

To ensure that multiple somewhat-off-axis charged particle detection events were caused by a single charged particle, it may be necessary to apply the coincidence method among the output signals of the two or more DPDs (or detector medium columns) that detect the somewhat-off-axis charged particle event. In the case where a charged particle transits multiple detector medium columns substantially parallel but not entirely parallel to their vertical (longitudinal) axes, the coincidence time window used to correlate the signals may be a relatively long period of time as compared to coincidence time windows required by prior art coincidence arrays of the same size. For this reason, the detectors and acquisition electronics used for such signal discrimination do not need to exhibit as fast a response as is required for prior art coincidence arrays. This is true because requiring that the charged particle transit a substantial percentage of the vertical length of a detector medium column (even if not requiring that the charged particle transit the entire length of the detector medium column) restricts the directions to which the DPD is sensitive to a cone centered on the pointing direction of the detector medium column and thereby reduces its rate of detection (per the underlying mechanism of DPD). This results in a comparatively lower signal rate, and therefore a lower cost of implementation for this slow version of coincidence method as compared to prior art coincidence method systems because the timing requirements of the optical sensors and coincidence circuitry for such an analysis are less stringent than in the prior art. The preceding discussion pertained to reducing the angular degeneracy/ambiguity of somewhat-off-axis charged particles. Note that the coincidence method is not required to render a complete trajectory measurement of an on-axis charged particle using DPD (where “on-axis” means substantially parallel to the detector medium column's longitudinal axis). The measurement of a somewhat-off-axis charged particle trajectory by two or more DPDs or one or more composite DPDs benefits from the application of a “slow version” of the coincidence method among nearby detector medium columns in order to reduce the angular degeneracy/ambiguity of the somewhat-off-axis charged particle's trajectory determination.

### Embodiment 6:“Indirect or Remote Coupling of the Optical Sensor(s) to the Detector Medium Column(s)”

In this embodiment, one or more detector medium columns 12 is placed in remote (or indirect) optical communication with one or more optical sensors 14 (such as a photodetector or an array of photodetectors such as a CMOS image sensor or CCD image sensor array) through a transparent material (or an air gap or a vacuum gap) instead of by joining the detector medium column(s) with the optical sensor(s) directly. This allows for a plurality of detector medium columns 12 to be monitored by as few as a single optical sensor 14 (or by as few as a single array of optical sensors). An optical element such as a lens, grating, aperture or filter may be employed between the optical sensor(s) and the detector medium column(s) to collimate or otherwise optically condition to photons incident upon the optical sensor.

This embodiment is implicit in Embodiment 2 (composite DPDs). FIGS. 6, 7, 8, 9, 10, and 11 depict indirect or remote coupling of the optical sensors(s) to the detector medium column(s). The concept is isolated in this embodiment because of its importance and broad applicability. The gap between the optical sensor 14 and the detector medium column 12 may comprise one or more transparent fluids or solids (such as air, water or optical elements), or vacuum, or it could comprise a wave guide (such as a non-detecting fiber optic).

Because an optical sensor 14 (or an array of optical sensors) can determine the direction of light incident upon it (through a variety of means including, but not limited to, a lens, an aperture, a filter, or a grating), the optical sensor used to monitor a plurality of detector medium columns can readily discriminate between the different detector medium columns that it is monitoring by virtue of the optical sensor's unobscured view of the terminating planes of the plurality of detector medium columns and the static, unique position of each detector medium column within that view. The lack of optical coupling required in the manufacture of the present embodiment, as well as a reduction in the number of optical sensors used in the present embodiment, may produce significant cost savings as compared to deploying a dedicated optical sensor(s) to monitor each detector medium column directly.

There are at least four possible combinations for remote monitoring of detector medium column(s) 12 in a DPD or composite DPD 10 system. Firstly, there is the instance of a single detector medium column which is remotely monitored by a single optical sensor. Secondly, there is the instance of a single detector medium column which is remotely monitored by a plurality of optical sensors. Thirdly, there is the instance of a plurality of detector medium columns which are remotely monitored by a single optical sensor. Fourthly, there is the instance of a plurality of detector medium columns which are remotely monitored by a plurality of optical sensors.

For comparison, there are also four possible combinations for direct monitoring of detector medium column(s) in a DPD or composite DPD. Firstly, there is the instance of a single detector medium column which is directly monitored by a single optical sensor. Secondly, there is the instance of a single detector medium column which is directly monitored by a plurality of optical sensors. Thirdly, there is the instance of a plurality of detector medium columns which are directly monitored by a single optical sensor. Fourthly, there is the instance of a plurality of detector medium columns which are directly monitored by a plurality of optical sensors.

As with all embodiments presented herein, this embodiment may be used in conjunction with any other embodiment.

### Embodiment 7:“Detector Medium Columns Formed From Naturally Occurring Transparent Fluid”

In this embodiment, pluralities of DPDs exhibit detector medium columns 12 which are formed from naturally occurring transparent fluid such as water or air, such as in an ocean, river, lake, aquifer, cave or in an atmosphere. This is achieved by enclosing the naturally-occurring fluid with a means for the internal reflection of photons which are produced by charged particles (such as muons) via Cherenkov radiation therein, and by placing one or more optical sensors 14 in optical communication with said enclosed region. The preferred cross section of the detector medium columns 12 in this embodiment may be polygons which can be tessellated (such as triangles or rectangles) because they may be packed together without overlap or gaps between the detector medium columns. However, detector medium columns 12 with cross sections that cannot be tessellated, such as circular cross sections, are also envisioned for use in this embodiment (and all embodiments).

### Embodiment 8:“DPD With One or More Detector Medium Columns That Exhibit 180-Degree Changes in the Axis Direction of the Column”

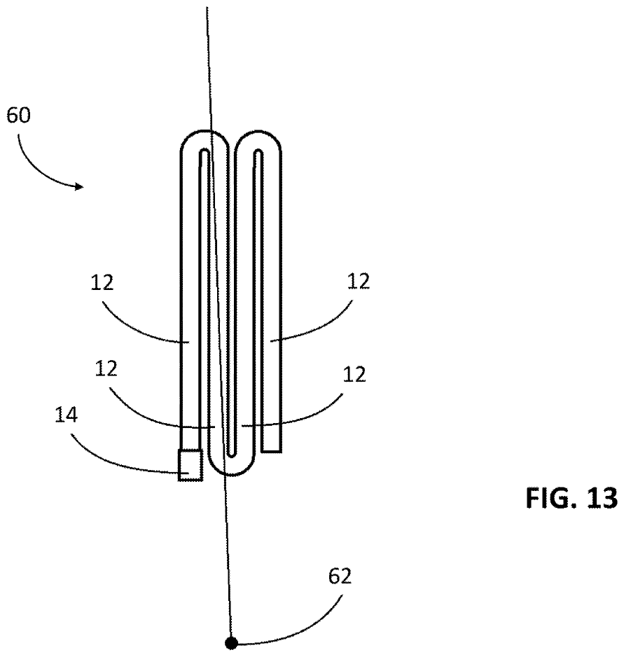

FIG. 13: Depicted is a DPD 60 with one or more detector medium columns 12 that exhibit changes in the axis direction of the column, or “bends”. An alternative description for this embodiment's arrangement of detector mediums is that there are four detector medium column ‘segments’ 12 that are optically coupled to each other in series by waveguides, such as a series of ‘bends’ comprising the detector medium column material or comprising a non-detecting waveguide. These ‘bends’ may exhibit 180-degree changes in direction as depicted, or may exhibit some other change in angle (including 0-degrees). The combined signal from all of the segments comprising the detector medium column are monitored (directly or remotely) by one or more optical sensors 14 (a single, directly-affixed optical sensor is depicted).

In this embodiment, the output of multiple detector medium columns that are connected end-to-end by waveguides of one kind or another (or, in an alternative description of the same embodiment, a single detector medium column exhibiting at least one change in axis direction) may be monitored by one or more optical sensors 14 such as photodetectors or cameras.

A charged particle 62 that travels down the entirety of one segment of the detector medium column deposits a maximal energy therein in the form of photons. This deposited energy in the form of photons is discriminated by an energy measurement (such as a power measurement or an intensity measurement) which is produced by one or more optical sensors. The photons migrate down the detector medium column 12 by refraction or reflection, including migrating around the ‘bends’ of the detector medium column. A reflective interface or coating may surround the detector medium columns (or waveguides) to facilitate total internal reflection of the photons (especially at the ‘bends’). One or more optical sensors 14 may be used to monitor the plurality of detector medium column segments, either directly or remotely.

This embodiment exhibits a plurality of detector medium column segments 12 that are connected to each other in series. Charged particles may enter into any of the plurality of cross-sectional footprints of the plurality of detector medium column segments and produce a signal which is detected by the optical sensor(s), instead of being restricted to the cross sectional footprint of just one detector medium column. The plurality of detector medium column segments may be monitored by as few as a single optical sensor. In the case of 180-degree bends in the detector medium column, the preferred direction of each detector medium column segment may be identical to the preferred direction of each other detector medium column segment and, therefore, the signal interpretation may be straightforward and unambiguous.

The optical components that may join the multiple segments of detector medium column may be made of non-detecting waveguides (such as fiber optics) instead of detector medium material as depicted and may be arbitrarily long and arbitrarily shaped.

The detector medium column segments 12 may be substantially nearby one another or may be separated by a distance which is large relative to diameter of the detector medium column segments 12. Similarly, the axis directions of the detector medium columns segments 12 may be arranged in any combination of directions, including a unidirectional arrangement.

### Embodiment 9:“Detector Medium Frustums”

In this embodiment, a DPD or a composite DPD 10 comprise one or more detector medium columns 12 that are longitudinally tapered, exhibiting one or more detector medium columns which are shaped like a frustum of a cone or a frustum of a pyramid (instead of a cylinder). That is, one or more detector medium columns may have a relatively smaller radius on one end and a relatively larger radius on the other end. This kind of detector medium column 12 is depicted in FIGS. 6 and 7.

In a composite DPD 10 with an tightly-packed arrangement of detector medium columns 12 that exhibit an exterior concavity or an exterior convexity, the advantage of a frustum shape over a cylinder shape is that it increases the volume of each constituent detector medium column while retaining a relatively small cross sectional area on one end of the detector medium frustum, all while retaining the one-dimensional elongation of the detector medium. In this and other embodiments where the constituent detector medium columns are shaped like frustums and are also stacked substantially against each other (thereby producing an exterior concavity or convexity), the ends of the detector medium columns which point inward (e.g. towards the one or more optical sensors) may be smaller in cross section than the ends of the detector medium column which point outwards (e.g. away from the one or more optical sensors). This allows for a higher percentage of the space within the confines of the composite DPD to be occupied by detector medium material, thereby increasing the charged particle flux detected by this embodiment. A benefit of increasing detected charged particle flux is to reduce the time required to produce a radiographic image or a tomographic image. As with all embodiments, this embodiment may be used in conjunction with any other embodiment.

A detector medium column that is shaped like a frustum of a pyramid and which has a cross-sectional area that can be tessellated (such as a triangle, square, or hexagon) may more fully geometrically maximize the percentage of space occupied by detector medium within the boundaries of a composite DPD which exhibits an exterior concavity or convexity. Such a detector medium shape could achieve a 100% packing ratio by fitting the boundaries of the constituent detector medium columns against each other without any space existing between them.

### Embodiment 10: A Composite DPD Comprising a Plurality of Detector Medium Columns Combined in Parallel Into a Single Waveguide, Which is Monitored by One or More Optical Sensors

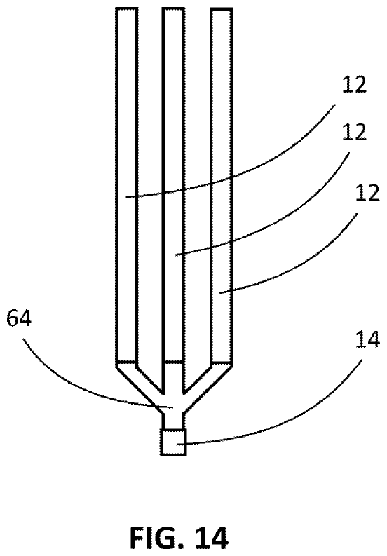

FIG. 14: In accordance with this embodiment, a plurality of detector medium columns 12 are combined in parallel into at least one waveguide 64 (such as at least one fiber optic) which is monitored by one or more optical sensors 14. The detector medium columns 12 may be substantially nearby one another or may be separated by a distance which is large relative to diameter of the detector medium columns. Similarly, the pointing directions of the plurality of detector medium columns may be any combination of directions, including a unidirectional arrangement.

### Embodiment 11: A Modified Version of DPD 66 Featuring a Detector Medium 68 Which is Elongated in Two Spatial Dimensions Instead of Just One Spatial Dimension

One or more aspects of this embodiment modifies the geometry of the detector medium column from that of a detector medium which is elongated in a single spatial dimension to that of detector medium which is elongated in two spatial dimensions, instead. Accordingly, the detector medium 68 for this embodiment takes the form of a two dimensional surface, such as a plane, a sheet, a disk, or any other substantially two-dimensional shape (as opposed to a substantially one-dimensional detector medium column in other embodiments). This substantially two-dimensional detector medium (the detector medium plane 68) is monitored by an optical sensor 14 or some other means for determining either the transit length of the charged particle 70 through the detector medium plane 68, or for determining the amount of energy deposited by the charged particle 70 into the detector medium plane 68. The one or more optical sensors 14 may monitor one or more detector medium planes 68 remotely, or may monitor one or more detector medium planes 68 directly.

FIG. 15: a single detector medium plane 68 is monitored by a single optical sensor 14 that is directly attached to the detector medium plane. The energy deposited into the detector medium plane by the charged particle 68 is in the form of photons and is optically contained within the plane by either 1) internal refraction, or 2) external reflection produced by a reflective surface or coating surrounding the detector medium plane (a reflective surface or coating for the purpose of optical containment is not shown in FIG. 15).

In the present embodiment, an output signal from one or more optical sensors which corresponds to a charged particle that traveled a maximal transit length through the detector medium plane corresponds to possible points of origin of the charged particle 70 which form a ring around the detector medium at a zenith angle of zero and spanning the full azimuthal angular range (with respect to a spherical coordinate system). This ring of possible charged particle trajectories is the greatest specificity in trajectory determination achievable by a single instance of the present embodiment, even from a charged particle that passes through the full elongated axis of the plane (with a maximal transit length through the detector medium plane). This is distinct from other embodiments (namely, those with one-dimensional detector mediums) that can produce a pair of possible charged particle trajectories instead of a ring of possible charged particle trajectories). The azimuthal degeneracy/ambiguity inherent in the substantially two-dimensional detector medium plane embodiment's charged particle trajectory determinations may be substantially mitigated by the application of a coincidence method among the output of two or more such embodiments.

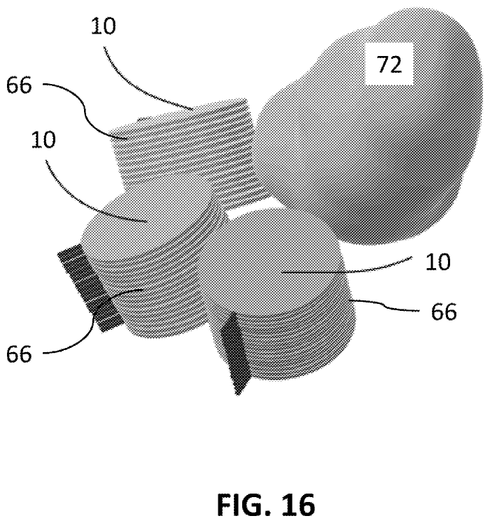

FIG. 16: three composite DPDs 10 with the major axes of their substantially two-dimensional constituent detector medium planes converging on a volume of matter 72 (such as an ore body). Each composite DPD is comprises a plurality of detector medium planes 66 arranged in “unidirectional” arrangements, with an optical sensor 14 affixed to each detector medium plane. The azimuthal angular degeneracy/ambiguity inherent in each constituent DPD's charged particle trajectory measurements in this embodiment may be substantially mitigated by an optional time-averaged comparison of charged particle flux data from among the three composite DPDs, independent of the coincident method.

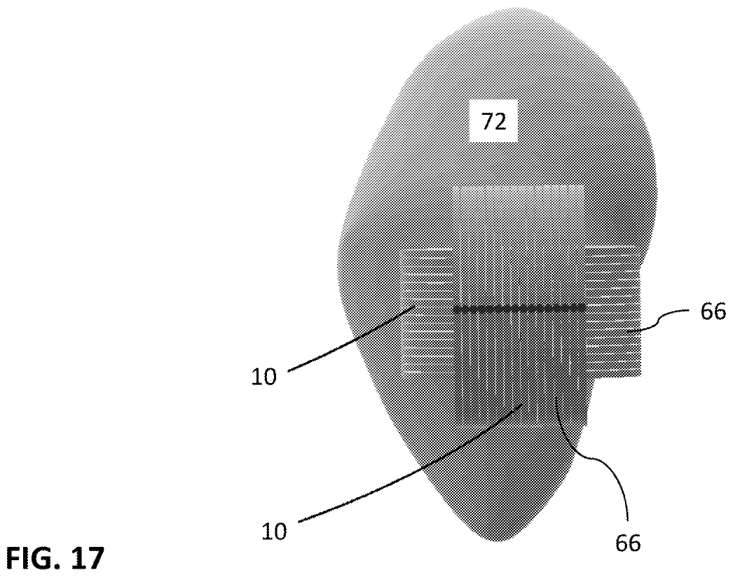

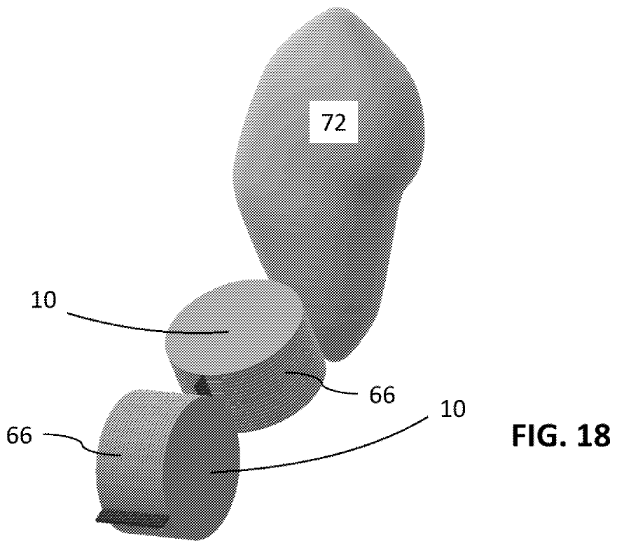

FIGS. 17 and 18 show composite DPDs 10 with detector medium planes that exhibit major planar axes that converge on a volume of matter 72. This arrangement may optionally employ a “slow” coincidence logic applied to the outputs of both composite DPDs 10. The coincidence logic can be “slow” because each composite DPD 10 restricts its flux by one entire spatial dimension (from the omnidirectional, 3-dimensional acceptance angle of a prior art charged particle detector to the ring-like, 2-dimensional acceptance angle of the present embodiment). The coincidence circuits required for that coincidence analysis can be simpler, slower, and cheaper than prior art coincidence logic circuits because the average time between successive charged particle detection events in a given detector is much greater in this embodiment than in a prior art coincidence method system with equivalent detector volumes.

The composite DPDs 10 in FIGS. 17 and 18 are oriented in orthogonal pointing directions, so that their angular acceptance apertures intersect in a substantially one-dimensional volume. The pointing directions of the planar axes of the composite DPDs 10 do not need to be strictly orthogonal, but in order to benefit from the refinement of the charged particle trajectory measurement that is provided by multiple viewing angles, the planar axes of the two or more composite DPDs 10 benefit from being pointed in at least somewhat different directions. The coincidence logic applied to the output signals of the composite DPDs 10 enforces the condition that the detected charged particle traversed the maximal transit distance through the detector medium planes of both composite DPDs 10 (that is, that charged particle was on-axis in both of the composite DPDs). In this and other embodiments, the application of the coincidence method to the output signals of one or more DPDs or of one or more composite DPDs may serve to “collapse” two or more ambiguous measurements of a charged particle into a single, unambiguous (or less ambiguous) directional measurement of the charged particle. The coincidence circuits required for that coincidence analysis can be simpler, slower, and cheaper than prior art coincidence logic circuits.

### Embodiment 12: A Composite DMD for Scattering Tomography

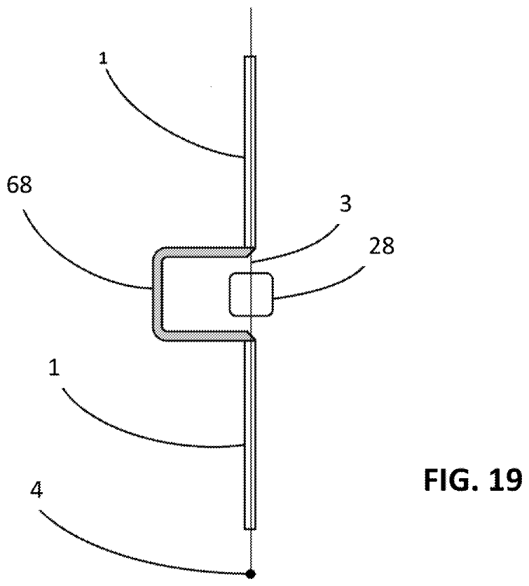

In this embodiment, two (or more) detector medium columns 1 are positioned in a substantially coaxial configuration, such that a first (incident) detector medium column is positioned directly above and in parallel alignment with a second (exit) detector medium column. A defined volume of space separates the two detector medium columns along their shared longitudinal axis. Subjects for tomographic analysis (such as volumes of matter or targets of interest 28) may be placed into this defined volume of space. Any photons produced by charged particles 4 passing through the first (incident) detector medium column travel from the first (incident) detector medium column into an optically coupled secondary waveguide 68 (such as a fiber optic). The secondary waveguide is routed around the defined volume of space separating the two detector medium columns and is optically coupled to the second (exit) detector medium column. Any of the two or more detector medium columns optically coupled in this way may be monitored by one or more optical sensors (either remotely or by being directly affixed). In FIG. 19, any photons produced by a charged particle in any of the optically coupled detector medium columns may be monitored by the one or more optical sensors. In the FIG. 19, the optical sensor is depicted as monitoring the second (exit) detector medium column, but the optical sensor may be located at any location along any of the two or more detector medium column or even along the secondary waveguide 68. This embodiment is used to determine the presence of non-scattered charged particle transmission events through the volume of matter under inspection, thereby allowing for the deduction of scattering events. The defined volume of space (the vacancy) between the two (or more) detector medium columns that comprise this embodiment, around which the secondary fiber optic is routed, may be of any size in order to accommodate any target of interest. The vacancy located between the two detector medium columns 1 may potentially range in size from very small (microscopic) to very large (tens of meters).

FIG. 19 (an example of Embodiment 12) is a side view of a composite DMD used for scattering tomography and scattering radiography, which exhibits two parallel detector medium columns 1 that are positioned coaxially such that one is directly over the other. The two (or more) detector medium columns 1 are optically coupled to each other by a waveguide 68 (such as a non-detecting fiber optic) and are in optical communication with one or more optical sensors. A vacancy or void exists in the region of space between the two or more detector medium columns, with the vacancy or void at least partially intersecting the shared longitudinal axis of two or more of the two or more detector medium columns. Targets of interest and volumes of matter may be inserted into this vacancy or void for inspection by charged particle radiography and tomography.

Embodiment 12 may be used to make measurements of charged particle transmission events through the volume of matter under inspection (target of interest), thereby deducing the absence of scattering of the charged particle in the volume of space between the detector medium columns. This “non-scattering measurement” is achieved while requiring zero instances of the coincidence method. The detector medium columns are monitored by one (or more) optical sensors. The first (incident) detector medium column is positioned directly above the second (exit) detector medium column and both columns are pointing in the same direction (parallel to each other) and are separated by a vacancy into which volumes of matter of targets of interest 28 may be placed. A secondary waveguide 68 (such as a non-detecting fiber optic) optically couples the first (incident) detector medium column to the second (exit) detector medium column, thereby routing the energy (in the form of photons) around the vacancy that is located between the first and second detector medium columns. A volume of matter under inspection (or a target of interest) may be inserted into the vacancy for inspection via scattering tomography or scattering radiography.

The purpose of the secondary waveguide 68 is to carry the electromagnetic energy in the form of photons (which were generated in the first (incident) detector medium column) around the one or more vacancies and to direct those photons into the second (exit) detector medium column, thereby combining the electromagnetic energy of both detector medium columns so that the combined energy may be monitored by one or more optical sensors which are adapted to directly or remotely receive that electromagnetic energy. The purpose of the secondary fiber optic in this embodiment is to allow for a target of interest (or a volume of matter) to be placed into the coaxial vacancy/void located between the two or more detector medium columns, while still producing the combination of the electromagnetic energy (in the form of photons) created by both (or all) detector medium columns into a single detector medium column or waveguide so that the combined energy may be monitored by as few as a single optical sensor on the basis of energy (or on the basis of power or on the basis of intensity, or on the basis of some other measurement that is substantially equivalent). Detector medium columns may be added to the optically coupled series of the present embodiment in the same manner as described above, creating multiple coaxial vacancies/voids, all while still being monitored by as few as a single optical sensor.

For illustration purposes, assume that the maximum amount of power that a single charged particle can deposit in the first (incident) detector medium column of this embodiment as depicted in FIG. 19 is 3×10⁻¹⁴ Watts (in the case of a “perfectly on-axis charged particle”, i.e. when the trajectory of the charged particle matches the orientation of the longitudinal axis shared by the two detector medium columns and intersects with both). Assume that the maximum amount of power that a single charged particle can deposit in the second (exit) detector medium column of this embodiment is also 3×10⁻¹⁴ Watts (in the case of a “perfectly on-axis charged particle”). Therefore, when a signal with a power of 6×10⁻¹⁴ Watts is detected by the optical sensor, such a signal means that the charged particle traveled through the full length of both detector mediums of this composite DPD, and therefore is known to have not scattered within the vacancy/void. In such a case, the charged particle is known to have traveled the full length of both detector medium columns and therefore, by geometry, the charged particle must have passed through the volume of matter/target of interest which is located in the vacancy between the two or more detector medium columns. Because the two or more detector medium columns are pointing in the same direction, a signal emanating from this DPD with a power of 6×10⁻¹⁴ Watts indicates that the trajectory of a charged particle must have remained unaltered during its transit through the vacancy (through the volume of matter/target of interest)—hence, the charged particle was not scattered.

Alternatively (not pictured), the detector medium column on the first (incident) side of the embodiment may exhibit a relatively larger length-to-width aspect ratio than the detector medium column on the exit side of the embodiment. This disparity in the relative length-to-width aspect ratios of the two detector medium columns may produce a relaxing of the angular acceptance of the second (exit) detector medium column as compared to the first (incident) detector medium column. This alternative detector medium column aspect ratio configuration for the present embodiment may afford this embodiment the ability to differentiate small-angle charged particle scattering events from large-angle charged particle scattering events by the same mechanism that non-scattering charged particle transmissions may be differentiated from charged particle scattering events in the case where the aspect ratios of the incident and exit detector medium columns are identical. By reducing the angular resolution of the second (exit) detector medium column (thereby widening its acceptance angle), low-angle scattering events of the charged particle may be registered as nominally-on-axis for both detector medium columns, allowing for a simplified, binary readout of the composite DPD. This reduction in the angular resolution of the exit detector medium column (corresponding to an increase in the acceptance angle of the exit detector medium column) may be achieved by either reducing the length-to-width aspect ratio of the exit detector medium column or by reducing the signal amplitude threshold that is applied to the exit detector medium column. A sub-maximal signal amplitude threshold applied to the second (exit) detector medium column allows for the trajectory measurement of charged particles that travel through a substantial portion of the second (exit) detector medium column, even if the charged particle did not travel the full length of the second (exit) detector medium column. In this and all embodiments, lowering the signal amplitude threshold applied to output of the optical sensor associated with a detector medium column has the effect increasing the acceptance angle of the associated detector medium column. In the context of the present embodiment, this allows the second (exit) detector medium column to detect charged particles that have been scattered by less than some known scattering angle (provided that the scattered charged particle still transits the second detector medium column).

Knowing whether or not a charged particle scattered while traversing the volume of matter under inspection may be of substantial import for material characterization efforts, even if the exact degree of scattering is not readily determined by this method. As described above, this embodiment is capable of determining an upper bound on the scattering angle, or alternatively, a range within which the scattering angle lies. By either altering the length-to-width aspect ratios of the two or more detector medium columns relative to each other, or by lowering the amplitude threshold used to discriminate the combined energy measurement to below that of the maximal possible energy, or by other means.

The fact that no coincidence method is required in this embodiment results in substantial cost savings over the prior art of charged particle scattering tomography for myriad reasons enumerated elsewhere, but also for an additional reason: in the prior art of scattering tomography, a coincidence event must be established on the incidence side of the volume of matter under inspection, a second coincidence event must be established on the exit side of the volume of matter under inspection, and a third coincidence event must be applied between the two aforementioned coincidence events in order to confirm that the charged particle scattering measurement referenced only a single charged particle. The first two coincidence events may indeed be obviated by one or more aspects already illustrated in other embodiments of the present disclosure, but the third coincidence event established among the two trajectory measurements is unique to scattering tomography systems, and it is this third coincidence event that may be uniquely obviated by the present embodiment. In this embodiment, no coincidence event may be required between the incident and exit detector medium columns to detect a non-scattering event by way of an energy measurement (such as by a power or an intensity measurement, or by an equivalent measurement). Similarly, scattering events may be detected by way of deduction; that is, if the charged particle did not transmit through the entirety of the second (exit) detector medium column, but it did transmit through the entirety of the first (incidence) detector medium column (or vice versa), then the charged particle is determined to have not transmitted through the vacancy—in that instance, the charged particle is deduced to have scattered within the vacancy.

Any number of detector medium columns may be joined in a similar manner to produce variations on this embodiment. Optical sensors in this embodiment may be directly affixed or remotely optically coupled to one or more waveguides or detector mediums. Other versions of this embodiment may employ a determination of the transit length of the charged particle through the detector medium instead of a determination of the amount of energy deposited by the charged particle in the detector medium—that transit length (as opposed to deposited energy) may used to determine the charged particle trajectory as in other embodiments.

The target of interest (volume of matter under inspection) of one or more aspects of one or more embodiments may be any geological formation (such as ore deposits, fluid reservoirs, volcanoes, faults, soil, gas fields, oil fields, caves, voids, mineral occurrences, geothermal reservoirs, geological resources, mountains, hills or overburden), large-scale infrastructure (such as mines, pipelines, dams, bridges, levees, tunnels, telecommunication hardware or electricity distribution hardware), industrial facilities (such as blast furnaces, refineries, nuclear reactors, power plants, waste repositories, leach piles, nuclear waste receptacles or landfills), biological or medical systems (such as tissues, organs, implants, medical devices, genetic samples, medical equipment or production lines), lifeforms, electronics, advanced materials and devices (such as semiconductors, microelectronics, composites, quantum computing substrates, or spintronic architectures), manufacturing and assembly lines, transportation vehicles (such as ships, trains, airplanes, helicopters, rockets, or drones), energy systems (such as batteries or fuel cells), major structures (such as buildings, underground facilities, or foundations), environmental or natural features (such as water columns, glaciers, icebergs, ice sheets, permafrost, pingos, reefs, burrows, atmosphere, clouds, or storms), packaging, artwork, rare-earth or mineral processing sites, heavy machinery assemblies, vaults, containers such as shipping containers, cargo, freight, space-based assets (such as satellites or orbital debris), subterranean assets (such as buried treasure or landmines), defense or security-related targets (such as ballistic plates or protective enclosures), advanced recycling or e-waste recovery lines, marine resources, robotic components, metamaterial or 2D-material doping lines, archaeological sites or materials, paleontological sites or materials, environmental remediation sites, quantum material growth or testing lines, photovoltaics, turbines and any related objects or combinations thereof.

As with all embodiments, one or more of the present embodiments may be employed in conjunction with a computer system to produce radiographs and/or tomographs indicative of charged particle interaction with a target of interest (volume of matter under inspection).

### Example Computing Device

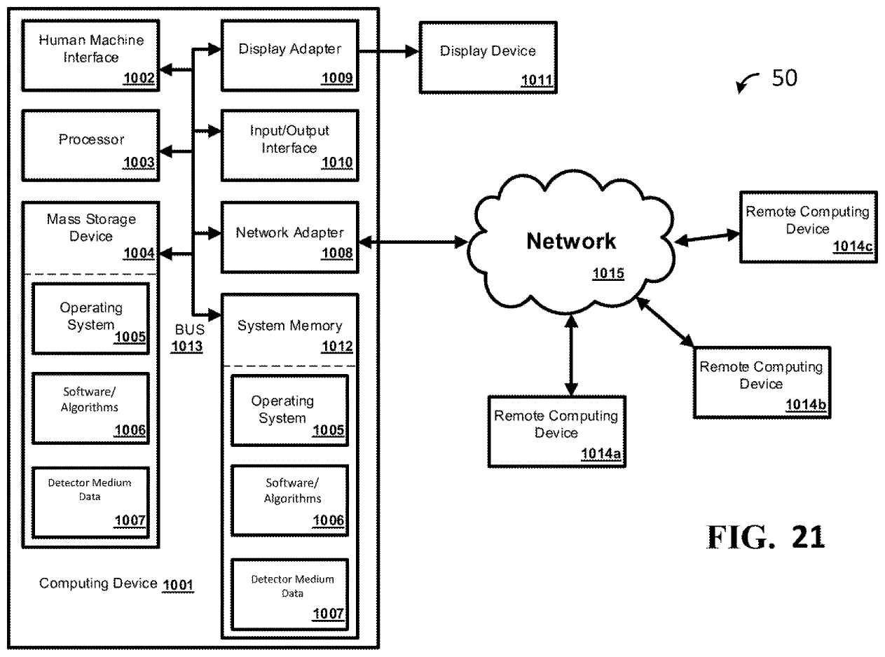

FIG. 21 shows an example system 50 including an exemplary configuration of a computing device 1001 for use with one or more DPD or one or more composite DPD disclosed herein. The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing. The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as detector medium data 1007 and/or program modules such as operating system 1005, and software/algorithms 1006 for determining the trajectory of charged particles through the one or more DPD or one or more composite DPD.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like. Any number of program modules may be stored on the mass storage device 1004. An operating system 1005 and software/algorithms 1006 may be stored on the mass storage device 1004.

A user may enter commands and information into the computing device 1001 using an input device. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display 1011 and computing device 1001 may be part of one device, or separate devices.

The computing device 1001 may operate in a networked environment using logical connections to one or more remote computing devices 1014a, b, c. A remote computing device 1014a, b, c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The remote computing devices 1014a, b, c, can perform respective operations of the system. Logical connections between the computing device 1001 and a remote computing device 1014a, b, c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the remote computing devices 1014a, b, c can optionally have some or all of the components disclosed as being part of computing device 1001. In various further aspects, it is contemplated that some or all aspects of data processing described herein can be performed via cloud computing on one or more servers or other remote computing devices. Accordingly, at least a portion of the system 1000 can be configured with internet connectivity.

All of the embodiments of the claimed disclosure described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A directional particle detector (DPD) comprising:
at least one detector medium, each detector medium of the at least one detector medium having a longitudinal axis and having a length extending along the longitudinal axis, each detector medium configured to react to a charged particle passing therethrough, and
at least one optical sensor configured to measure an amount of energy deposited in each detector medium of the at least one detector medium resulting from a reaction to the charged particle passing therethrough.

Aspect 2: The DPD according to aspect 1, wherein the at least one detector medium comprises two or more detector mediums.

Aspect 3: The DPD according to aspect 2, wherein the longitudinal axes of respective detector medium of the two or more detector mediums are transverse to one another.

Aspect 4: The DPD according to any of aspect 2-3, wherein the longitudinal axes of respective detector medium of the two or more detector mediums are substantially parallel to one another.

Aspect 5: The DPD according to any of aspects 2-4 further comprising a support structure, wherein the support structure comprises the at least one optical sensor.

Aspect 6: The DPD according to aspect 5, wherein the two or more detector mediums are coupled to the support structure in a porcupine arrangement.

Aspect 7: The DPD according to aspect 5, wherein the two or more detector mediums are coupled to the support structure in a stack of fans arrangement.

Aspect 8: The DPD according to any of the preceding aspects, wherein the measurement of the amount of energy deposited as a result of the respective detector medium reacting to the charged particle passing therethrough is a power measurement or an intensity measurement or an equivalent measurement, wherein the measurement of the amount of energy deposited does not include photon counting.

Aspect 9: In combination, a DPD according to any of the preceding aspects and a computing device communicatively coupled to the DPD, the computing device configured to:

receive a signal generated by the at least one optical sensor, the signal indicative of the amount of energy deposited in each detector medium of the at least one detector medium resulting from the reaction to the charged particle passing therethrough
determine, based on the received signal, the amount of energy deposited by the charged particle into each detector medium that reacted to the charged particle, and
determine, based on the determined amount of energy, a trajectory of the charged particle with respect to the longitudinal axis of the respective detector medium that reacted to the charged particle.

Aspect 10: The combination according to aspect 9, wherein the trajectory of the charged particle is determined by comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

Aspect 11: The combination according to aspect 9, wherein the trajectory of the charged particle is determined by determining a transit length of the charged particle through the respective detector medium and comparing the transit length to the length of the detector medium along the longitudinal axis, wherein, when the length of the detector medium along the longitudinal axis is equal to the determined transit length, the determined trajectory of the charged particle is along the longitudinal axis of the respective detector medium, when the length of the detector medium along the longitudinal axis is greater than the determined transit length, the determined trajectory of the charged particle is at an angle to the longitudinal axis of the respective detector medium.

Aspect 12: The combination according to any of aspects 9-11, wherein the computing device is further configured to produce one or more radiograph or one or more tomograph based on the received signal.

Aspect 13: A plurality of DPDs according to any of aspects 1-8, wherein at least one DPD of the plurality of DPDs is positioned to detect a charged particle that passed through a volume of matter.

Aspect 14: A plurality of DPDs according to any of aspects 1-8, wherein at least one first DPD of the plurality of DPDs is positioned to detect a charged particle before passing through a volume of matter and at least one second DPD of the plurality of DPDs is positioned to detect the charged particle after passing through the volume of matter.

Aspect 15: The plurality of DPDs according to aspect 14, wherein the trajectory of a charged particle through the at least one first DPD of the two or more DPDs is compared to the trajectory of the charged particle through the at least one second DPD of the two or more DPDs to determine if the charged particle was scattered during transit through the volume of matter.

Aspect 16: The plurality of DPDs according to aspect 15, wherein the trajectory of a charged particle through the at least one first DPD of the two or more DPDs is compared to the trajectory of the charged particle through the at least one second DPD of the two or more DPDs in order to determine information about the angle by which the charged particle was scattered.

Aspect 17: A method of determining charged particle trajectory through a directional particle detector (DPD):
measuring, via an optical sensor of the DPD, an amount of energy deposited in each detector medium of at least one detector medium of the DPD resulting from a reaction to the charged particle passing through at least one detector medium of the at least one detector medium, wherein each detector medium of the at least one detector medium has a longitudinal axis and a length extending along the longitudinal axis;
determining, based on the measured amount of energy, a trajectory of the charged particle with respect to the longitudinal axis of the respective detector medium that reacted to the charged particle.

Aspect 18: The method according to aspect 17, wherein determining the trajectory of the charged particle comprises comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

Aspect 19: A method of characterizing a volume of matter, the method comprising:
positioning at least one first directional particle detector, each first directional particle detector of the at least one first directional particle detector configured to determine the trajectory of a charged particle passing therethrough after the charged particle passes through the volume of matter.

Aspect 20: The method according to aspect 19, the method further comprising:
positioning at least one second directional particle detector, each second directional particle detector of the at least one second directional particle detector configured to determine the trajectory of a charged particle passing therethrough before the charged particle passes the volume of matter, and

Aspect 21: The method according to aspect 20, further comprising:
determining whether the particle was scattered in the volume of matter by comparing the determined trajectory of the charged particle before passing through the volume of matter to the determined trajectory of the charged particle after passing through the volume of matter.

Aspect 22: The method according to any of aspect 19-21 further comprising:
producing one or more charged particle radiographs or one or more charged particle tomographs indicative of charged particle interaction with the volume of matter.

What is claimed is:

1. A directional particle detector (DPD) comprising:
at least one detector medium, each detector medium of the at least one detector medium having a longitudinal axis and having a length extending along the longitudinal axis, each detector medium configured to react to a charged particle passing therethrough, and
at least one optical sensor configured to measure an amount of energy deposited in each detector medium of the at least one detector medium resulting from a reaction to the charged particle passing therethrough.

2. The DPD according to claim 1, wherein the at least one detector medium comprises two or more detector mediums.

3. The DPD according to claim 2, wherein the longitudinal axes of respective detector medium of the two or more detector mediums are transverse to one another.

4. The DPD according to claim 2, wherein the longitudinal axes of respective detector medium of the two or more detector mediums are substantially parallel to one another.

5. The DPD according to claim 2 further comprising a support structure, wherein the support structure comprises the at least one optical sensor.

6. The DPD according to claim 5, wherein the two or more detector mediums are coupled to the support structure in a porcupine arrangement.

7. The DPD according to claim 5, wherein the two or more detector mediums are coupled to the support structure in a stack of fans arrangement.

8. The DPD according to claim 1, wherein the measurement of the amount of energy deposited as a result of the respective detector medium reacting to the charged particle passing therethrough is a power measurement or an intensity measurement or an equivalent measurement, wherein the measurement of the amount of energy deposited does not include photon counting.

9. In combination, a DPD according to claim 1 and a computing device communicatively coupled to the DPD, the computing device configured to:
receive a signal generated by the at least one optical sensor, the signal indicative of the amount of energy deposited in each detector medium of the at least one detector medium resulting from the reaction to the charged particle passing therethrough
determine, based on the received signal, the amount of energy deposited by the charged particle into each detector medium that reacted to the charged particle, and
determine, based on the determined amount of energy, a trajectory of the charged particle with respect to the longitudinal axis of the respective detector medium that reacted to the charged particle.

10. The combination according to claim 9, wherein the trajectory of the charged particle is determined by comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

11. The combination according to claim 9, wherein the trajectory of the charged particle is determined by determining a transit length of the charged particle through the respective detector medium and comparing the transit length to the length of the detector medium along the longitudinal axis, wherein, when the length of the detector medium along the longitudinal axis is equal to the determined transit length, the determined trajectory of the charged particle is along the longitudinal axis of the respective detector medium, when the length of the detector medium along the longitudinal axis is greater than the determined transit length, the determined trajectory of the charged particle is at an angle to the longitudinal axis of the respective detector medium.

12. The combination according to claim 1, wherein the computing device is further configured to produce one or more radiograph or one or more tomograph based on the received signal.

13. A plurality of DPDs according to claim 1, wherein at least one DPD of the plurality of DPDs is positioned to detect a charged particle that passed through a volume of matter.

14. A plurality of DPDs according to claim 1, wherein at least one first DPD of the plurality of DPDs is positioned to detect a charged particle before passing through a volume of matter and at least one second DPD of the plurality of DPDs is positioned to detect the charged particle after passing through the volume of matter.

15. The plurality of DPDs according to claim 14, wherein the trajectory of a charged particle through the at least one first DPD of the two or more DPDs is compared to the trajectory of the charged particle through the at least one second DPD of the two or more DPDs to determine if the charged particle was scattered during transit through the volume of matter.

16. The plurality of DPDs according to claim 15, wherein the trajectory of a charged particle through the at least one first DPD of the two or more DPDs is compared to the trajectory of the charged particle through the at least one second DPD of the two or more DPDs in order to determine information about the angle by which the charged particle was scattered.

17. A method of determining charged particle trajectory through a directional particle detector (DPD):
measuring, via an optical sensor of the DPD, an amount of energy deposited in each detector medium of at least one detector medium of the DPD resulting from a reaction to the charged particle passing through at least one detector medium of the at least one detector medium, wherein each detector medium of the at least one detector medium has a longitudinal axis and a length extending along the longitudinal axis; and
determining, based on the measured amount of energy, a trajectory of the charged particle with respect to the longitudinal axis of the respective detector medium that reacted to the charged particle.

18. The method according to claim 17, wherein determining the trajectory of the charged particle comprises comparing the amount of energy deposited into each detector medium that reacted to the charged particle to a calculated amount of energy deposited into the respective detector medium when the charged particle travels the length of the respective detector medium along an axis parallel to the longitudinal axis, wherein, when the calculated amount of energy is equal to the determined amount of energy, the determined trajectory of the charged particle is along the longitudinal axis of the respective detector medium, and when the calculated amount of energy is greater than the determined amount of energy, the determined trajectory of the charged particle is at an angle to the longitudinal axis of the respective detector medium.

19. A method of characterizing a volume of matter, the method comprising:
positioning at least one first directional particle detector, each first directional particle detector of the at least one first directional particle detector configured to determine the trajectory of a charged particle passing therethrough after the charged particle passes through the volume of matter.

20. The method according to claim 19, the method further comprising:
positioning at least one second directional particle detector, each second directional particle detector of the at least one second directional particle detector configured to determine the trajectory of a charged particle passing therethrough before the charged particle passes the volume of matter.

21. The method according to claim 20, further comprising:
determining whether the particle was scattered in the volume of matter by comparing the determined trajectory of the charged particle before passing through the volume of matter to the determined trajectory of the charged particle after passing through the volume of matter.

22. The method according to claim 19 further comprising:
producing one or more charged particle radiographs or one or more charged particle tomographs indicative of charged particle interaction with the volume of matter.
